(19) United States
(12) Patent Application Publication
(10) Pub. No.: US 2007/0183633 A1
(43) Pub. Date: Aug. 9, 2007

(54) Identification, verification, and recognition method and system

(76) Inventor: Andre Hoffmann, Dinslaken (DE)

Correspondence Address: WILLIAM COLLARD;COLLARD & ROE, P.C., 1077 NORTHERN BOULEVARD, ROSLYN, NY, 11576, US

(21) Appl. No.: 10/593,863

(22) PCT Filed: Mar. 22, 2005
(86) PCT No.: PCT/EP05/03049

§ 371 Date: Sep. 22, 2006

(30) Foreign Application Priority Data
Mar. 24, 2004 (DE) 10 2004 014 875.9
Aug. 18, 2004 (DE) 10 2004 039 937.9

(51) Int. Cl. G06K 9/00; G06K 9/22

(52) U.S. Cl. 382/116

(57) ABSTRACT

The invention relates to the field of identification and verification of living beings with the aid of the form, shape, contour, silhouette, surface structure, color and characteristics especially of sets of teeth, individual teeth, tooth parts, and the relation thereof to the facial and body structures surrounding the same. Systems that are suitable for recording the person-related characteristics are based on detection by means of laser, a camera, sensor, image, color, etc., for example. Disclosed are a series of possibilities and constructions on how a “dental fingerprint” can be detected so as to generate data. The invention does away with problems inherent to previous systems in this field as a result of the great advantage created by the independence of the teeth from facial expressions. The detection of the surface is to indicate whether a being is alive or dead. The inventive method and system can be used wherever the identity of a person has to be proven in order to grant access or control, for example. Potential users include the bank sector, computer security, e-commerce, public authorities, enterprises, the health sector, telecommunication, and private entities.

This invention relates to the field of identification and verification, short authentication of dead and/or living things, i.e., persons, individuals, animals, etc., as well as of dead material, e.g., objects, items, materials, etc., and to this end makes use of at least one laser scan (system) and/or a camera, and/or image acquisition and/or a sensor and/or detector and/or an apparatus and/or an instrument, or the like, suitable for measuring and/or acquiring and/or obtaining information from, for example, (individual) forms, partial forms, shapes, contours, outlines, volumes, features, (distinctive) points, (individual) structures, surface consistency (e.g., surface roughness, microstructures, rough depths, etc.), external, internal geometry, color, structure, design, reflected light, its spectral composition, its beam path, reflected light patterns and/or a portion and/or a section thereof and/or the like, which are visible and/or not visible with the naked eye (one and/or all of the above from which information and/or data can be obtained is referred to with the term “identification feature(s)”, in particular from and/or for application on natural (living and dead, naturally occurring teeth) and/or artificial (e.g., false teeth, work to replace teeth or tooth substance, dental and/or restorative work, crowns, bridges, fillings, inlays, prostheses, etc.) dentition and/or tooth and/or teeth and/or parts of teeth and/or parts and/or sections thereof and/or this and/or these and/or related fields. In this context, the vocabulary named by the inventor-is “dental fingerprint”.

Previously known, and hence not eligible for protection, was the forensic medical identification of dead persons only by inspecting patient records, in particular by having the forensic expert making a direct visual evaluative comparison of special characteristics manifest in the X-ray and based on X-ray opacity (e.g., bridges, crowns, fillings) to those inherent in the skull dentition. In the process, a check is performed to determine whether the bridge or crown manifested as a shaded area on the X-ray can also be found in the dentition of the dead person. This forensic medical identification focuses exclusively and is dependent on the presence of obviously present special characteristics, and is hence greatly limited, e.g., cannot lead to an objective if no special characteristics are present in an untreated or healthy dentition, if the dentition of the dead person is incomplete owing to post mortem circumstances, or if only one tooth or a few teeth were found, etc.

Previous possible methods for biometric person identification and verification are realized by way of a camera scan of the face, while measuring stipulated feature structures (DE 196 10 066 C1), the camera-based finger, hand-(EP 0 981 801), and iris scan (DE 692 32 314 T2), retinal detection, the classical visual comparison of fingerprints and the face, the comparison of voice, coordinated movement and handwriting.

Methods like these are to be used in any cases where the identity of a person must be verified, e.g., in order to ensure access authorization or rights, management authorization. These include safety-relevant facilities or safety-sensitive areas (factories, airports, manufacturing plants, border crossings, etc.), automated tellers, computers, cell phones/mobile telephone, protected data, accounts and cashless transactions, cross-border traffic, equipment, machines, transport equipment, control units (cars, airplanes, etc.), etc.

However, the previously known methods mentioned above are associated with major disadvantages. For example, iris recognition does not work in lenses that are dull, blind people and eyeglass wearers; problems are encountered in non-glare-protected eyeglasses or color contact lenses, and the eye of a dead person cannot be used. The finger or hand scan is susceptible to contamination caused by contact. Finger injuries, excessively dry or fatty skin, or old fingerprints on the sensor can also make identification impossible. The geometric dimensions of hands do not vary significantly. Previous facial recognition is not very reliable; for example, false results are brought about by beards, eyeglasses or situation-induced facial expressions. Signatures, voice, and coordinated movement are already intraindividually variable, i.e., variable within one and the same individual, e.g., based on currently prevailing emotions, and the time required for a recognition process, for example at an automated teller, is very high, so that this type of system can only be used within a very narrow framework. Systems like these can also fail as the result of environmental influences, e.g., altered light. In addition, it has not yet been possible to identify objects, persons or living beings located a greater distance away, e.g., from the camera.

Problems of this nature associated with the previously known methods mentioned above for identification and verification are no longer encountered in the methods described in the patent, which can be used in all areas described previously in the literature and above, and anywhere that for example living beings, persons, individuals, materials, objects, items, etc. are to be identified and/or verified. Further, not least the teeth provide one or more fixed points for acquiring these surrounding structures to which the acquisition systems can be geared, wherein the inclusion of the “tooth” in the acquisition via previously known identification systems (e.g., facial recognition, iris scan, etc.) is also to be protected by this application.

In addition to identification features or portions thereof, e.g., for dentition, teeth and/or tooth segments, the claim also makes use of those for the body and/or parts thereof for the identification and/or verification of living beings, persons, etc., in particular in combination.

Claims that refer to at least a part or section of a living or dead body (e.g., of persons and/or living beings and/or individuals and/or animals, etc.) denote at least by example a body part, the head, the face, facial segments, facial sections, the ear, the nose, the eye, in particular the cornea, the arm, the hand, the leg, the foot, the torso, fingers, toes and/or a part and/or section thereof, which are used for the authentication of persons, living beings and/or individuals.

There are probably no two teeth, let alone dentitions, on earth that match in terms of external and internal geometry and appearance, and hence no two individuals who exhibit similarity if only in the form, color, structure, or other characteristic of a tooth. The same holds true for dental and/or restorative work of all kinds, which enhance of replace teeth or tooth substance. The individuality of these hand-crafted results, which are based on the individual aesthetic sensibility of the dentist, the dental technician, the patient and resultant desires, the technical skill and individual preconditions dictated by the individual anatomical circumstances, is just as unique, and hence usable for purposes of identification and verification.

According to the patent, the “identification features” are acquired and/or information is obtained in the corresponding method e.g. via laser scanning and/or a sensor and/or detector and/or camera system and/or contact scanning with or without lighting, etc., after which the data obtained in this way are processed accordingly. The same holds true for the acquisition of a tooth, teeth and/or dentition-proximate areas (e.g., body, head, face, parts thereof, etc.), which can additionally also be drawn upon for identification and/or verification. Based on the claims, this data acquisition can take place directly in the mouth and/or selected feature of the person, living being and/or on an image of any kind and/or a old and/or negative relief of the feature selected for making the identification and/or verification and/or on a model of the latter. The negative relief or model can exist in the form of data or in the form of a material. The negative can be converted into positive data by running it through a computer program, or used directly.

Living beings, objects, items, etc. likewise have a uniquely characteristic form, shape, contour, and outline, along with surface consistency, characteristic features, identification features, including artificially created markings that can be seen or are no longer visible to the naked eye, which also represent characteristic, individual features based upon which this dead material, the item or the object can be detected, recognized, identified and/or verified. In addition, the acquisition of surface structure provides information about whether the feature used for identification and/or verification or the used area is living, dead or artificial.

The methods according to the invention scan or acquire and/or detect bodies, objects, surface structures, identification features, etc. using suitable laser systems and/or detector and/or sensor and/or camera systems, etc., with or without lighting for at least the region selected for evaluative identification and/or verification. In cases where lighting is used, systems like these have a light transmitter, which here comprises a laser system that emits laser light, and a light receiver that absorbs the light. When using a laser on humans, it is recommended for safety reasons that a laser safe for the above or for identification purposes according to DIN be used, e.g., type 1 or 2 lasers. In method 1, the shape, contour, form, volume, outline, (top) surface structure, e.g., the surface relief, macro relief, micro relief, roughness, etc. of the tooth, tooth section, teeth and/or dentition is used for identification. For example, laser procedures work based on the triangulation method, in which a transmitted laser beam is deflected by a rotating mirror, and hits the object at the point recorded by an EMCCD, CCD camera, sensor, or the like, the pulse method, which is rooted in acquiring the run time of the transmitted, reflected and received laser beam, the phase comparison method (“Phasenvergleichsverfahren”), stereoscopy, structured light projection (“Lichtschnittverfahren”) method, etc. This approach makes it possible to generate distance images reflecting the geometric conditions of the surrounding objects and/or intensity images for extraction, identification and surface identification independently of external ambient lighting, etc. in this way, individual measured points can be allocated by varying hue, e.g., light gray points can be allocated to measured points that are farther away, and dark gray points to those situated closer by. After laser scanning (optical procedure using laser light, in particular allowing a targeted, e.g., linear and/or meandering, scanning and/or only defined detection of individual points, thereby enabling a higher optical, and in particular spatial, resolution by comparison to methods involving normal light (e.g., daylight)), an unstructured data volume (scatter) can be obtained, which can also be interlinked with polygons. In addition, these data can be diluted and structured by computer. Further, an attempt can be made to process the data writing in geometric elements, thereby carrying out an approximation. The points are read out and sorted using software, for example, and if necessary processed further into three-dimensional coordinates using a CAD program (computer aided design).

Data converted into 3D structures can also allow virtual sections of the body or object, the dimensions of which, e.g., cross sectional length, shape, circumferential length, etc., can also be used for purposes of identification or verification, a variant described in the claims. However, these data can also be generated without virtual sections. In addition, there are also other laser procedures that can also be used for the aforementioned purposes, and also utilized according to the claims. Further, a combination with a camera or imager can enhance a color image, for example the intensity image, and data acquisition performed exclusively with a camera enables an identification and/or verification based on colors and/or based on the combination of form or outline data, etc., and color, for example. A color analysis is also enabled per the claims, and can take place via the RGB color system, the L*a*b* and/or one or more of the other color systems and/or other data (information), etc., for example. Color data can be used both as reference data, as well as a password and/or code replacement, for example, by the search program as well. This takes the data flood into account, and enables an advance selection via color data or an acceleration of reference data selection in a procedural variant as described in the claims.

Another variant covered in the claims describes color acquisition via a laser system, which yield spectral data and/or data through beam deflection (angle change) and/or in the case of laser light with a spectrum via the spectral analysis of the reflected light. A previous method can be combined with the laser system at all levels of acquisition. Measuring (e.g., color meter) and laser light combined make it possible to reduce data distortion, e.g., on curved surfaces, with knowledge of the angle of incidence of the light on the tangential surface of the object and the angle of the reflection beam relative to a defined line or plane. The beam path of the measured light from the color meter can be acquired via the laser beam that takes the same path to the measured point, and included in the color data. By determining the curvature of the feature, the beam path progression can also be simulated, or folded into the data acquisition.

In addition, the laser-based distance image can be overlaid with the intensity image. This makes it possible to localize and acquire the form of the object or person or sections and/or areas thereof.

If the object is to be acquired in its entirety, e.g., the dentition or tooth, data acquisition must take place from several vantage points and/or locations and/or several perspectives using one and/or more laser acquisition device(s), cameras, sensor, detectors and/or acquired images, etc., simultaneously or consecutively. The locally isolated coordinate systems must now be transformed into a uniform (overriding) coordinate system. For example, this is accomplished using linking points or via an interactive method making direct use of the different scatter points. Coming the above with a digital camera yields photorealistic 3D images.

Acquisitions performed with an accuracy in at least the millimeter range at greater distances <50 m or in the micrometer range (1 micrometer) or better at close distances enable precise identification or verification. For example, an accuracy of ±15 micrometers stays realistic even during quick scans of more than several centimeters per second. The point density or data volume can be increased or decreased. In the method described in the patent, it is required that at least two points be scanned, and that their relation in space and/or to each other be determined. Even so, to guard against confusion and false result, falsely verified or falsified persons, living beings, objects, etc., it is recommended that as many points as possible be acquired, while still remembering that the more points are used for the procedure, the longer it takes to achieve a result owing to the data volume. Algorithms fix a three-dimensional, metric space, in which the distances between various biometric features are clearly mathematically defined. According to the patent, then, the data need not be processed into a 3D image or the simpler 2D image variant per the claims and/or data need not be generated for this purpose; rather, identification only requires that the data obtained by the corresponding acquisition system or corresponding acquisition systems at some processing level behind the laser, sensor, camera, acquired image and/or the detector and/or behind the acquisition of data or information come at least as close to the model acquisition data during renewed acquisition that the system, based on its desired tolerance or sensitivity for this purpose, either confirms the veracity or match, or rejects it if the data are not close enough.

Of course, the statements regarding laser scans only serve as an illustration, and can also accomplish the objective of obtaining information and/or data for purposes of identification and/or verification in a plurality of other methods.

Model data acquired by laser and/or some other way in conjunction with a person and/or the living being and/or the personal data, e.g., name, age, residence, etc. of the person make it possible to unambiguously identify or correspondingly verify the person or living being during renewed data acquisition, if the newly acquired data come close to the model or reference data within the tolerance limits.

The significant advantage to teeth or human dentitions is that they are unaffected by facial expressions, and in most cases are relatively rigidly connected with the facial part of the skull. However, teeth do change in form over time as the result of caries, abrasion, erosion and dental surgery, and also in color owing to films or ageing, in particular after the age of 40. All processes are slow and creeping, and are further slowed and sometimes halted given the currently high level of dental care and prevention. Statistics show that caries diseases taper off, and will in the foreseeable future go from what was formerly a widespread disease to what will be a negligible peripheral occurrence. Despite this fact, attention must now still be paid to this feature-changing factor during the identification and verification process. The claims propose that, after each dental surgery of relevance for identification and verification, the reference data be reacquired, initiated by the person, e.g., by pushing a button on a separate acquisition unit and/or detection unit and/or upon request. As described in the patent, the initial acquisition and/or new acquisition can also be performed for this purpose directly at the site relevant to identification or verification, e.g., at the bank counter, in the vehicle cab, in the passenger area, at the border or safety-relevant access point, etc., and/or directly by means of the same equipment used for identification or verification based on the new data in conjunction with the already stored data, or using a separate acquisition unit that need not be directly correlated with the local identification and/or verification site. This reacquisition of reference data can here take place automatically, e.g., after a preset number of acquisitions for the respective identification or verification case, or after prescribed intervals as a function or not as a function of the acquisitions. Both variants are covered in the patent. The newly acquired data must here be within a tolerance range selected by the manufacturer or operator of the identification or verification system to be used as the new reference data. The acquired data are first stored, and then become reference data if they lie within the tolerance range or close to the previous reference data. The reference data can also be automatically reacquired if the identification system finds deviations that are still within the prescribed tolerance limits. In this case, the system is provided with a deviation limit within the tolerance range, which, if exceeded, initiates a reference data update. The reference data reacquisition can take place via a separate device, or directly using the identification and verification system. Reference data reacquisition can ensue either before or after the identification or verification, as well as simultaneously or in one and the same identification or verification process, as also described in the patent.

The data acquisition for the reference data or data acquisition for purposes of identification or verification can be performed directly on the tooth, teeth or dentition, the body, face, a part thereof, etc., for example, but can also take place based on a negative, e.g., molding negative, e.g., with a molding compound (e.g., silicone, polyether, etc.) used in dental practice, etc., which is at first moldable, and becomes hard or flexible in a reaction. The patent also describes the acquisition of a model, e.g., generated by molding with the aforementioned compound, for example, wherein molding takes place by stuffing or casting, etc., with a material, such as plaster, plastic, etc., or milling, with or according to the data (e.g., copy milling, mechanical scanning and milling, etc.).

As described in the claims, data acquisition (reference data and/or data reacquisition in identification cases) is also possible even via scanning through contact or mechanical scanning by means of equipment suitable for this purpose (e.g., a stylus, mechanical scanner, copying system, etc.), also using the original, copy or molding negative, and is protected under the claim.

Both reference data and newly acquired data can be acquired by means of a camera, sensor, detector and/or laser scan, for example.

Other variants covered by the patent include the acquisition of personal features like dentition, teeth, tooth sections, and body parts exclusively by means of one or more camera system(s), image acquisition, sensor, detector, camera and/or laser systems, both with and without lighting, and/or with or without color determination.

Image acquisition, sensor and/or detector and/or camera and/or laser acquisition and/or otherwise acquired information or data relating to the identification features can relate to the dentition, teeth, one tooth and/or tooth section and/or body, head, face, ear, nose, eye, arm, hand, leg, foot, torso, finger and/or toe and/or a portion and/or a section and/or a feature thereof. This applies both to the reference data and to the data acquired in the case of identification or verification.

Acquisition performed via laser during identification or verification can take place using only a section or dotted line, for example, but these must lie within the reference scatter or at any height desired, while still within the reference-scanned areas. For example, a line or partial line can over at least two points in a data area for the dentition acquired as the reference in order to arrive at a decision during an identification or verification procedure. Theoretically, it would be enough to make the decision described if the same two points as in the reference data acquisition process were to be found and acquired in the course of identification or verification.

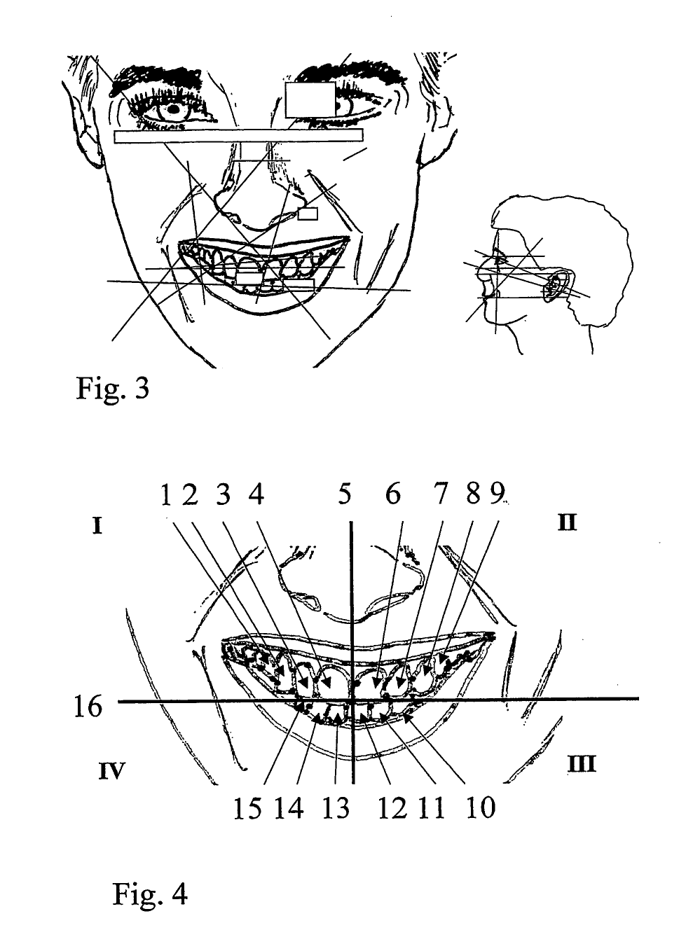

All of the aforementioned can also hold true for data and/or data acquired exclusively via laser scan and/or detector and/or sensor and/or camera and/or image acquisition system or the like, and in slightly modified form also for acquisition through the latter. For example, if the entire dentition and/or body and/or parts thereof is stored in the reference data file, the entire dentition or entire body or parts thereof need not be determined again for purposes of data acquisition in the identification or verification process, e.g., a partial dentition, a tooth, a section of tooth, a part of a face, etc., and/or a section and/or a line or partial line and/or feature on them, is here sufficient to acquire only two points in relation to each other and/or to and/or in space and/or to the surrounding structure. A line, section or several sections can be measured or acquired in all spatial directions and at all angles, e.g., perpendicularly, horizontally, diagonally, meanderingly, e.g., to the tooth axis, image axis, on the feature, etc. FIG. 3 here shows a few of nearly countless possibilities by way of example. Countless acquisition variants are possible. In this case, it is possible to equip the device at the identification or verification site more easily, and with a laser system and/or detector and/or sensor and/or camera and/or image acquisition system, which dies not have to acquire the tooth form from several directions, for example. Rather, a small section is sufficient to obtain the data through measurement or acquisition at any arbitrary area, independently of the location and posture of the head, head positioning and body positioning. Subsequent processing takes place by examining data agreement within all stored or this single stored dentition and/or body and/or area thereof. Data relations or value relations contain the measured points and their relations to each other in the figurative or literal sense can only be found for the same individual and the same localization of these points, and make it possible to identify and/or verify not just the person and/or living being and/or object, but also the localization within the acquired area used for this purpose, if the latter was linked, for example, with a marking and/or coding and/or information, etc. Therefore, the objective to subsequent processing is to bring the data and/or section and corresponding relation in line with the reference data and/or the 2D and/or 3D reference image, which if transmitted as an image and/or in real time and/or in a figurative sense to a 2D and/or 3D representation, is checked for agreement or proximity by shifting, rotating, etc. the new partial form on the reference form, with an attempt to bring the latter in line.

Identification and/or verification via the body, body part, face, facial part, e.g., bone (segment), skeleton, (personal) feature and the like take place in the same manner. The complete feature or portion thereof can also be acquired in the form. In terms of identification or verification, it would be sufficient here as well to measure a portion, e.g., a line, for example one that forms a grade horizontal, perpendicular, diagonal to a defined on the feature, e.g., longitudinal axis, or incorporate all other angular variables. It would theoretically also be enough to measure only two points during identification and/or verification, if these two points are the same and/or exhibit the same relation to each other and/or the environment as the reference. If the reference data pool with data acquisition of the entire feature, e.g., dentition and/or face and/or body, etc., is present, only a small section is required for renewed data acquisition as part of the identification or verification process. One advantage to the method and equipment here is that it now makes no difference whether the laser beam for scanning or the beam path for image acquisition, etc., e.g., of the body, face and/or teeth, etc., comes from whatever side, inclined from above or below, or at whatever angle. The person can hence be identified or verified for this procedure independently of position.

Since laser-acquired points can be measured within micrometer or even nanometer accuracy, structures not visible to the naked eye can also be acquired, and used for purposes of identification or verification as described in the claims. For example, the same holds true for image acquisition and utilization, wherein use is here made of zoom, magnification, magnifying lenses, corresponding optical equipment and the like.

All surfaces of the human body accessible to laser scan can be utilized. They can be acquired in both their visible form, shape, contour and/or the outline or a portion thereof, and as the surface structure that is also not visible to the naked eye (e.g., relief, micro relief, roughness, etc.), and used in this manner as a personal feature for identification or verification. Every human has varying shapes relative to his/her body, face, ear, etc., that are unique to him/her alone. The claims also describe combining the form, shape, contour and/or outline and/or a portion thereof along with the surface structure of the body, head, face, ear, nose, arms, legs, hands, feet, fingers and/or toes, etc., with that and/or those of the dentition, teeth, tooth section and/or feature. Such a combination makes it possible to establish relations between parts and/or points of the body or point groups, e.g., in the area of the face, ear, etc., and points, areas, point groups for the dentition and/or teeth and/or tooth (sections). These relations can be distinctive points and/or features, ore even any x-type desired. The relations and points to be used can be prescribed by the program, or set by the user or users of the system. With respect to laser-assisted identification and verification, at least the two points required for this purpose are sufficient, and points, scatters, scatter segments or corresponding data can also be utilized.

If the camera acquisition system described in the claims is to be used to identify the dentition, tooth, or tooth section exclusively or in conjunction with other technology, a data record that can be generated in 3D may be acquired using several cameras, but at least one camera. However, generation can basically also take place in 2D and/or, while maintaining the relations for the dentition, which naturally is arced, representation can be accomplished through reconstruction within the image plane, for example. If generated and/or reconstructed 3D reference data are known, identification and/or verification only require a 2D representation and/or their data and/or data about the area to be evaluated, which are to be brought in line with the reference and/or, given a positive case, should be in the tolerance range of the latter. The same also holds true for the use of a laser system and/or combination of laser and camera system or other technologies, which also constitutes a procedural variant described in the claims.

A laser-acquired structure (e.g., dentition, head, face, etc.) as reference data makes it possible to exclusively then perform a renewed data acquisition by means of camera, sensor, detector and/or image acquisition, etc., for purposes of identification and/or verification, wherein the camera-acquired data do not absolutely have to be 3D, and 2D acquisition is sufficient. The same holds true in cases where other systems are combined with each other.

For example, the same applies with respect to other combinations of process engineering or types of acquisition.

While acquiring the form, shape, contour and/or outline, surface structure (e.g., relief, micro relief, roughness, etc.) of the dentition, teeth, a tooth, tooth sections, body, head, face, ear, nose, eye, arm, hand, leg, foot, torso, finger, toe and the like and/or a segment and/or a section thereof by means of laser and/or camera and/or sensor and/or detector and/or image acquisition, the data, image and/or acquired structure here always reveal features and/or information and/or patterns that can also be used for identification and/or verification.

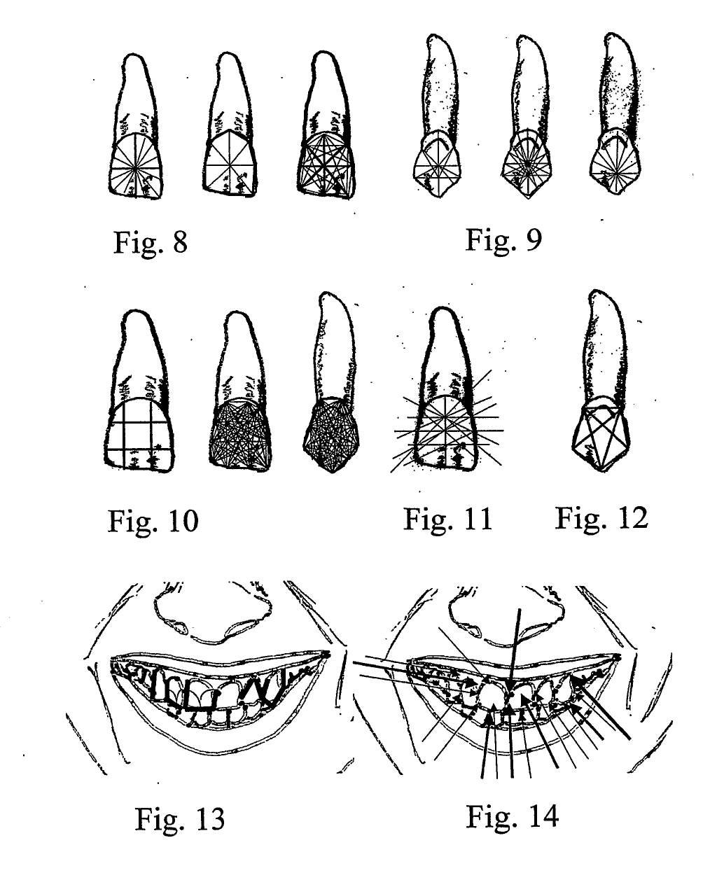

8 upper jaw teeth and/or lower jaw teeth can be used in the case of smiling, and 10 in the case of laughing, or significantly less or more teeth in other instances, and dentists number these teeth based on their position in the jaw and by quadrant (I, II, II [sic], IV) from 11 to 18, from 21-28, from 31-38 and from 41-48 (see FIG. 4: 1=14, 2=13, 3=12, 4=11, 5=vertical separating line that separates quadrants I and II as well as III and IV, 6=21, 7=22, 8=23, 9=24, 10=33, 11=32, 12=31, 13=41, 14=42, 15=43, 16=horizontal separating line that separates quadrants I and IV as well as II and III). The location and position of the teeth and the natural separating line represent usable features. Also suitable for identification and/or verification and/or data formation and/or usable as features are the distinct points in the dentition and tooth, e.g., the mesial corner (7) and distal corner (4), cervical crown end (arrow), cusp tip or canine tooth tip (2), incisor edge (1<mesial side or edge (5), distal side or edge (3), mesial incline (9), distal incline (8) and, according to FIG. 6, approximate contacts or approximate spaces between two teeth (examples 1, 4), the vestibular surface (7), the midline and approximate area between the tooth 11 and 21 (4) as a representative example for several and/or all other teeth, papillary tips of the gums (3), here between tooth 22 and 23 as a representative sample for others, the cervical and/or gingival edge (2), mesial corners of 31 and 41 (5), incisal edge or distal corner of 12 (6). Several selected distinct points of dentition are marked with arrows by way of example on FIG. 14. The corner points and/or distinct points interconnect to form lines, e.g., as selectively shown on FIGS. 8, 9 and 12. Points of a tooth can also be linked with points of an adjacent or nonadjacent tooth.

Examples of structural lines (natural or distinct lines) and or connecting lines based on distinct points that can be used for purposes of identification and/or verification include: approximate sides, incisal sides, cusp inclines, tooth equator, tooth crown axis, connection between cusp tips, corner points and/or gum papillae and/or tips of adjacent or nonadjacent between or among each other, with it being possible to form additional lines by supplementing other distinct points.

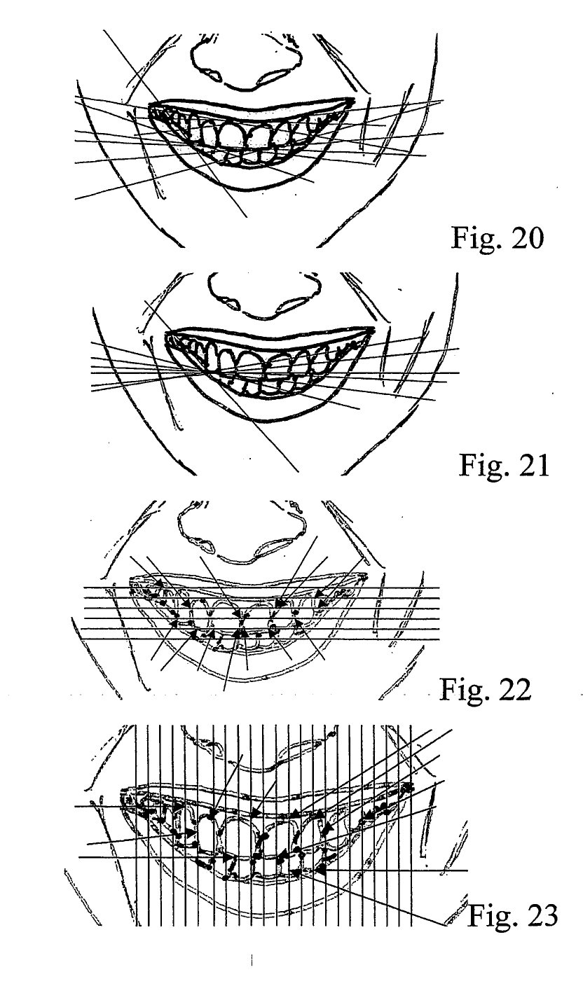

Constructed points arise when connecting lines or elongated lines, tooth boundaries, boundary structures, continuity changes or interruptions and/or other connecting lines and/or constructed lines intersect with or among each other figuratively or literally (almost every drawing contains such points). FIGS. 10, 11, 19, 20, 21, and 40 show examples of selected lines. The resultant intersecting points or constructed points can also be connected in this way.

All points can be literally or figuratively interconnected, e.g., including (natural) distinct points, intersecting points, constructed points, both with and among each other. Newly established connecting lines create newly constructed intersecting points, so that new generations and/or hierarchies of connecting lines and intersecting points or constructed points can always be produced, and are also usable, so that the number of usable points and lines that can be constructed can approach infinity. The same holds true for angles, surfaces and areas formed by lines and/or points.

In a variant described in the claims, the tooth surface can be further divided. Selected drawings illustrating this are shown on FIG. 8-12. However, this division can also be realized via the tooth crown axis and/or horizontal separating line, the anatomical equator (largest circumference to crown axis), etc., for example.

As a result, those points used that were already constructed in a first generation incorporate exponentially more usable points and connecting lines, and hence more angles, surfaces, areas and patterns for each generation.

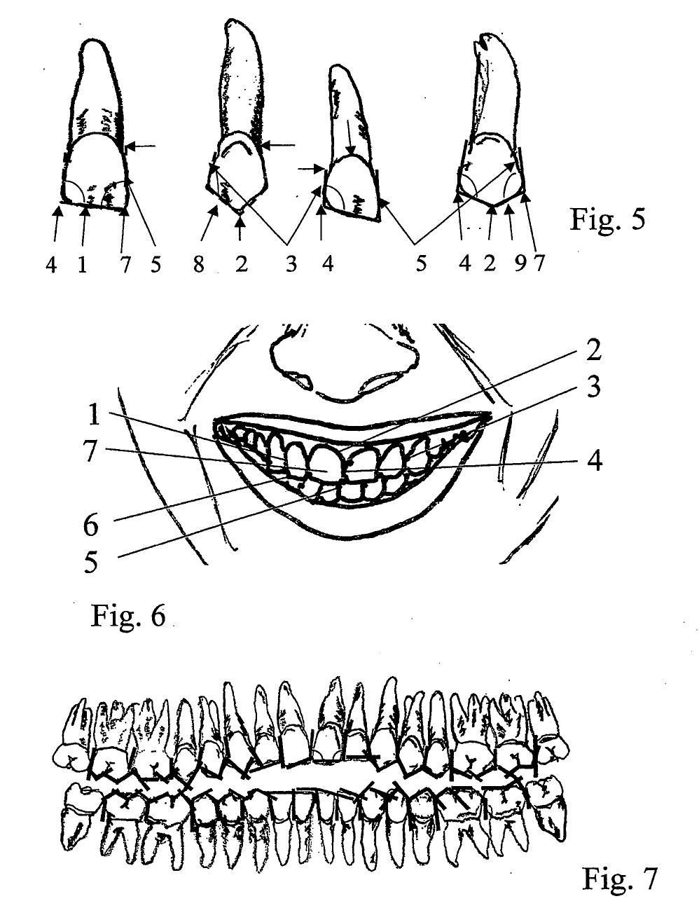

For example, angles between natural edges (e.g., between mesial and distal cusp inclines, mesial approximate sides and incisal sides, approximate sides, incisal sides, distal approximate sides and incisal sides, mesial approximate sides and mesial-side inclines, the distal approximate side and distal-side incline, the mesial approximate side and distal-side incline, the distal approximate side and mesial-side incline (see FIG. 5, 7 for selected examples) of adjacent and/or nonadjacent teeth (FIG. 7, 13) and/or lines and/or connecting lines and/or constructed lines (see FIG. 8, 9, 10, 11, 12 for sample lines) can be used for purposes of identification and verification. One or more surfaces between these natural edges, distinct lines, constructed lines, etc. and/or the connection of distinct and/or constructed points can also be used for identification and verification, just as newly constructed points.

The entire length of one or more lines or straight lines can be used, while the entire size of one or more angle(s) and surface(s), or spaces can be utilized. The size of the surface and spaces, angles, along with the length of the lines can hence serve as features given knowledge, for example, of the object-lens or object-device distance via the reference data acquisition utilized for identification and/or verification. Image reconstruction (e.g., zoom, magnification, reduction, rotation, etc.) here makes it possible to reconstruct these variables, and hence make absolute use of them. Distorted angles, line lengths and/or surfaces can be reconstructed given knowledge of the entire structure, or help in reconstructing the feature range and/or bringing the newly acquired image in line with the reference image, for example.

If the angles, lines and/or surfaces coincide with the model in another variant described in the claims, the head outline and/or sectional outline and/or features must also provide a match in conjunction with the overall image and/or feature proportions, etc., given a positive identification and/or verification.

Another variant described in the claims utilizes the structural proportions and/or relations between defined lines, edges and/or connecting lines and/or relations between defined angles and/or the relations between defined surfaces and/or planes and/or spaces and/or among each other.

Examples include the relation between the length of two or more identical or different edges of one and the same tooth, immediately adjacent and/or nonadjacent teeth, e.g., of the kind mentioned above, the path between the differences in level of adjacent or nonadjacent (incisal) edges, the lengths of constructed lines and/or connecting lines between distinct and/or constructed points, the angles and/or surfaces and/or their relation between two or more identical or different edges and/or sides mentioned above of one and the same tooth, immediately adjacent and/or nonadjacent teeth and/or jaw areas and/or constructed lines and connecting lines between each other and/nor with distinct lines and/or edges.

Which lines, angles, planes or surfaces, spaces are used and how many, the appearance of surfaces, e.g., how many corners they have, how many distinct natural and/or constructed points are used, etc., can be determined based on the safety requirements of the person using this method, for example. The more points, lines, angles and/or surfaces and/or spaces are used, the more precise the result of identification and/or verification will be, but the data volumes that need to be compared will also be greater, and the acquisition, search and measuring process will take longer.

One way that data can be compressed is to combine the data. For example, points can be combined into lines, lines into surfaces, surfaces into spaces, and spaces into patterns, thereby keeping the data volume low.

In this way, at least one feature and/or point and/or angle and/or surface and/or space (advantage: data compression) generate relations and patterns that can also be used for identification and/or verification purposes in another procedural variant.

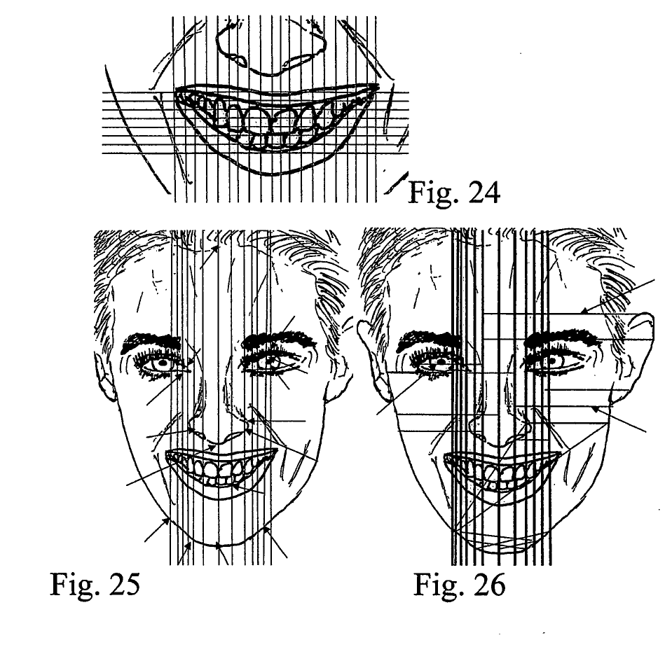

In one variant described in the claims, use is made of a grid (section on FIG. 24) fabricated for all feature acquisitions alike, which is actually or virtually superposed over the data, the image and/or acquisition section and/or feature to be evaluated, and initiates a classification. For example, it is oriented by one of more distinct points of the dentition and/or a tooth (section) and/or a face and/or part of a face and/or body and/or body part. The grid alignment can here be oriented toward at least one distinct point, feature, feature group and/or feature range and/or constructed point via at least one defined intersecting point and/or a defined point within a defined grid element. The image information content of grids, e.g., generated via feature accumulation, and/or the number of continuity changes and/or continuity interruptions, can in this way be used for identification and/or verification, e.g., through color saturation of gray hues, color density, pixel density, bits, etc., within a grid element.

The image information content achieved via feature accumulation and/or number of continuity changes and/or continuity interruptions, e.g., through gray hue color saturation and/or accumulation of measured points, etc., can also be used for feature detection, and does not absolutely require a grid or lines, etc., in another variant of the method.

A system and/or device can provide data and/or image information about surfaces, spaces, grid elements, and regions, e.g., as the result of its information content (e.g., about color hues, gray scaling, quantities and density of measuring points, etc., e.g., of the image surfaces, pixels, etc.), providing evidence as to the structures and distinct points and/or features. This requires at least one image acquisition unit, e.g., a camera, detector and/or a sensor, with or without lighting, and/or laser scanning unit, etc., image and/or data processing, and/or data analyses.

The use of a neuronal network can improve feature recognition and detection and/or processing via the system.

To this end, another variant described in the claims uses the resultant intersecting points between distinct edges, lines, constructed lines and/or connecting lines with horizontal lines and/or vertical lines of the grid and/or the newly constructed lines between newly constructed intersecting points and/or angles and/or surfaces and/or patterns produced as a result. In the drawing, arrows point to several selected structures intersected by horizontal lines (FIG. 22) and vertical lines (FIG. 23), which can also be used for the construction of connecting lines and/or for identification and/or verification by the relation between the points. FIG. 18 here shows three connection examples (dashed lines) from among nearly limitless possibilities.

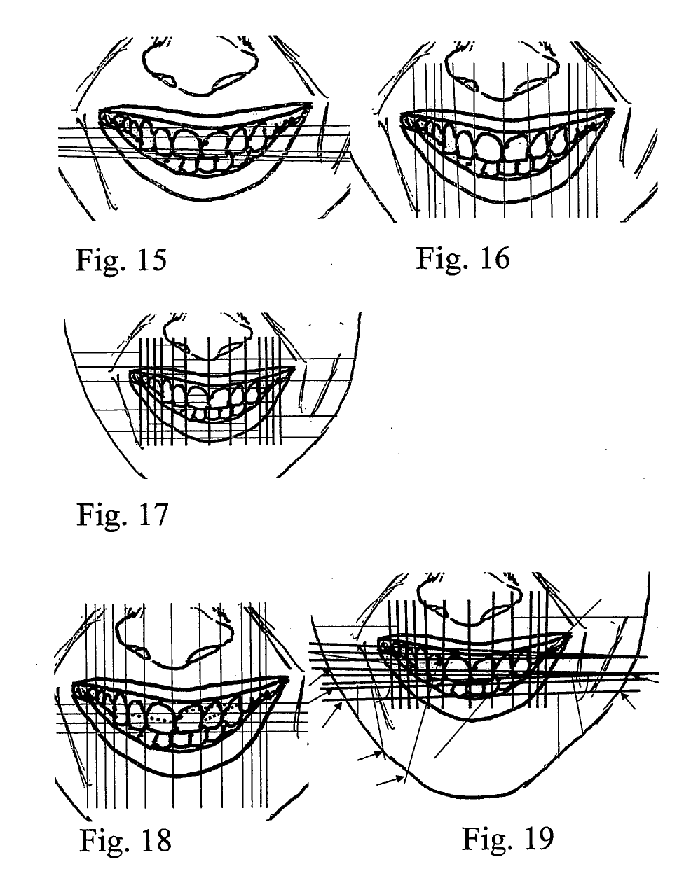

An individual grid orients its horizontal lines toward incisal edges of identically designated (e.g., middle upper incisors, lateral or incisor teeth, first or second primary molars or molars, etc.) (FIG. 15) and/or differently designated teeth and/or their midpoints toward distinct or constructed points, etc., and/or its vertical lines toward the approximate spaces and/or mesial and/or distal edges/lines (see FIG. 16 for selected examples), and/or toward distinct or constructed points, crone centers, crown thirds, etc. (see FIG. 18, 19 for selected examples). The individual lines have individual distances from each other (see FIG. 17 for selected examples), and individual angles are here produced between lines. See FIG. 19 for selected examples. Individual information can be derived from the above.

The same statements made for the individual lines and individual grid can also apply to the fabricated grid.

In addition, information can be obtained by intersecting the lengthened grid lines with the edge of the grid and/or image and/or with prescribed, defined planes or lines. The same holds true for individually constructed and/or distinct lines. The information is similar to that of a bar code on the edge of the grid and/or image, and can be read using the right technology, e.g., through bright and dark acquisition. The lines can also be planes in the 3D version.

All of the material covered above can be used in combination or be combined.

Associations and relations between the remaining body and/or one or more personal features and a tooth (section), the teeth and/or dentition can also be established via distinct points, constructed points, connecting lines, constructed lines, angles, and/or surfaces. This is possible in both absolute and/or relative terms. Distinct and/or constructed points, connecting lines, constructed lines, angles, and/or surfaces and/or spaces generate relations, patterns, data, information, etc., that are useful for identification and/or verification. Also useful are features, distinct points, constructed points, connecting lines, constructed lines, angles and/or surfaces, relations and/or patterns exclusively in the area of the head, face, ear, remaining body and/or parts thereof, along with the relation of the latter to those of the dentition.

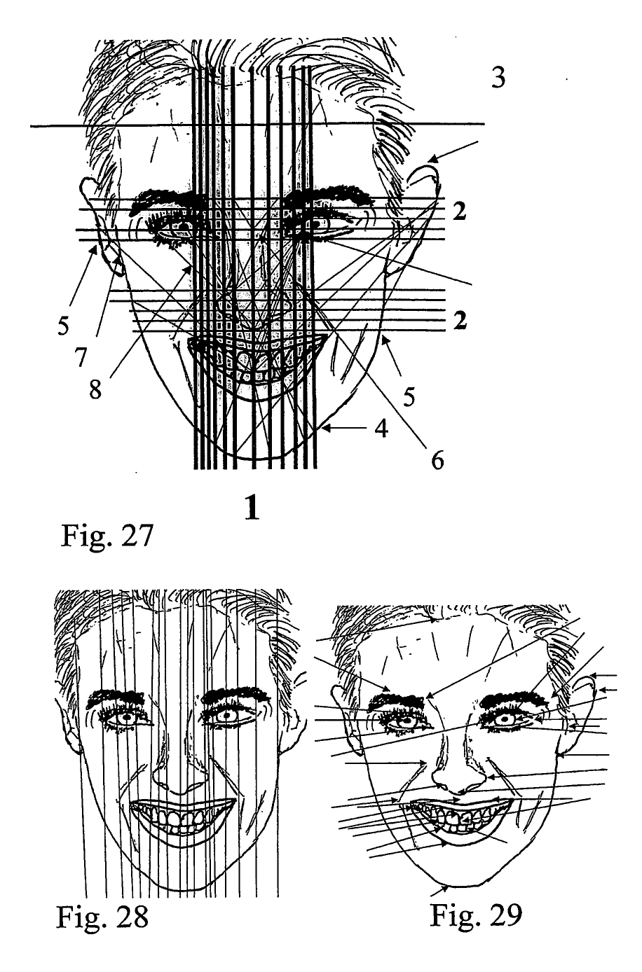

Individual dental-based vertical lines also intersect distinct facial structures, and exhibit distances or distance relations relative to the facial outline, for example (see FIG. 25, 26 for selected examples). The same holds true for dental-based horizontal lines (FIG. 15, 19). FIG. 25 shows an example of several dental-based vertical lines, along with selected intersecting points with natural structures (arrow). FIG. 26 shows lengths of several perpendicular lines on vertical lines, which come into contact with the facial outline or distinct points. FIG. 26 and FIG. 27 further show a few selected diagonal connecting lines between intersecting points. Vertical lines of the face (face-based vertical lines) (see example on FIG. 29) can be used alone and/or in combination with dental-based vertical lines (see example on FIG. 28), or with body-based vertical lines. Vertical lines are formed by a perpendicular, which passes through a distinct point and/or feature. Vertical lines also form relations between each other. The same holds true for horizontal lines and grids. In like manner, dental-based vertical lines (I) with face-based horizontal lines (2) can form a grid and/or intersections. FIG. 27 additionally shows some constructed connecting lines and intersecting points between the natural structure and a face-based horizontal line (5), the facial structure and a dental-based vertical line (4), connecting lines of an intersection of vertical line and horizontal line to another (6), the point of intersection between the connecting line of two distinct points and a vertical line (8), the intersection of a connecting line with a distinct line (7). Distinct points can be used to generate an individual grid for the face, wherein the lines must pass through all symmetrical features and/or at least one of them (3 see selected example for upper horizontal line) to be feature-defined. FIG. 44 shows a possible individual grid, for which what has already been stated above concerning individual grids in the tooth area applies. The same holds true for the constructed lines and/or connecting lines and/or the grid network in the area or partial areas of the body, head and/or face and/or a combination thereof and/or parts thereof with the dentition and/or parts thereof.

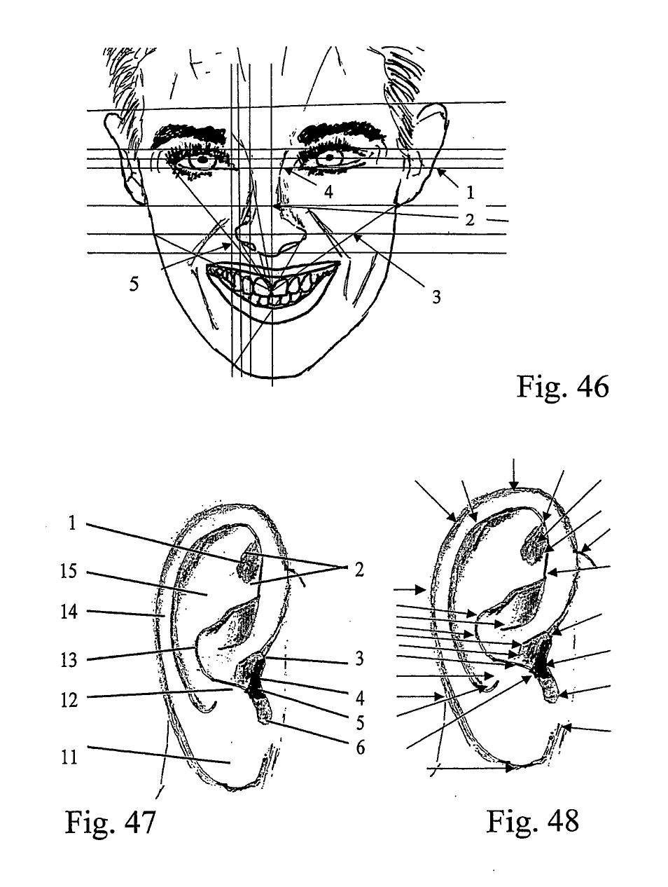

The dashed diagonals on FIG. 43 represent selected connecting line examples. The grid network can exhibit both more uniform linear relations and non-uniform (FIG. 44) lines distributed over the viewed area (FIG. 45). Vertical lines can be oriented toward features or distinct points (FIG. 44), and/or toward intersecting points, e.g., between the horizontal lines and body structures (FIG. 45). FIG. 46 depicts a few selected examples for intersecting points, which were generated by intersecting a face-induced horizontal line with a facial contour (1), with a facial structure (4), intersecting a face-related vertical line with a corresponding horizontal line (2), a face-related horizontal line (3) and vertical line (5) with a connecting line between a distinct point or a face-related horizontal line with the approximate papilla between tooth 11 and 21.

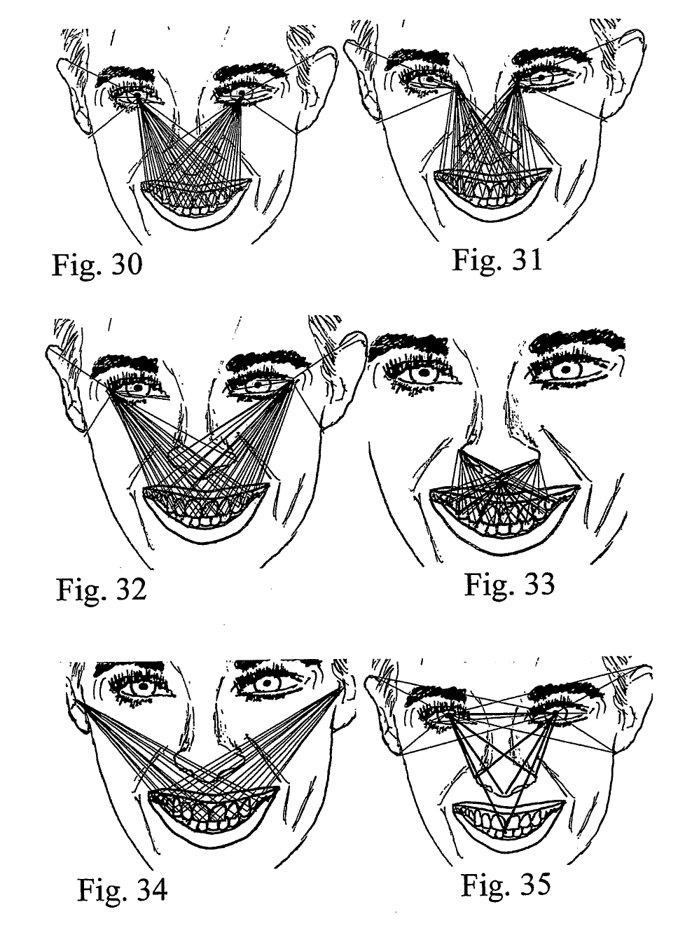

Additional data can be obtained, e.g., about the length or relation of the pupil (FIG. 30), the inner canthus (FIG. 31), the outer canthus (FIG. 32), the lateral nasal wing and/or subnasale (FIG. 33), distinct ear points (FIG. 34) relative to one or more distinct (e.g., corner point or end point of tooth edges or sides, approximate points) and/or a constructed point on the teeth. The locality of the pupil in space (pupil position) can be determined based on the relations, e.g., between the pupil and all other distinct locations on the face (selected examples are shown on FIG. 29, see arrow), e.g., between the canthuses and the teeth. Requesting that a marking be fixed on the acquisition device or utilizing a mirror in which the person to be identified and/or verified is to look makes it possible to acquire the viewing direction and/or head and/or body position via the pupil position, and provides the capability to also reconstruct bodily relations or feature relations relative to each other.

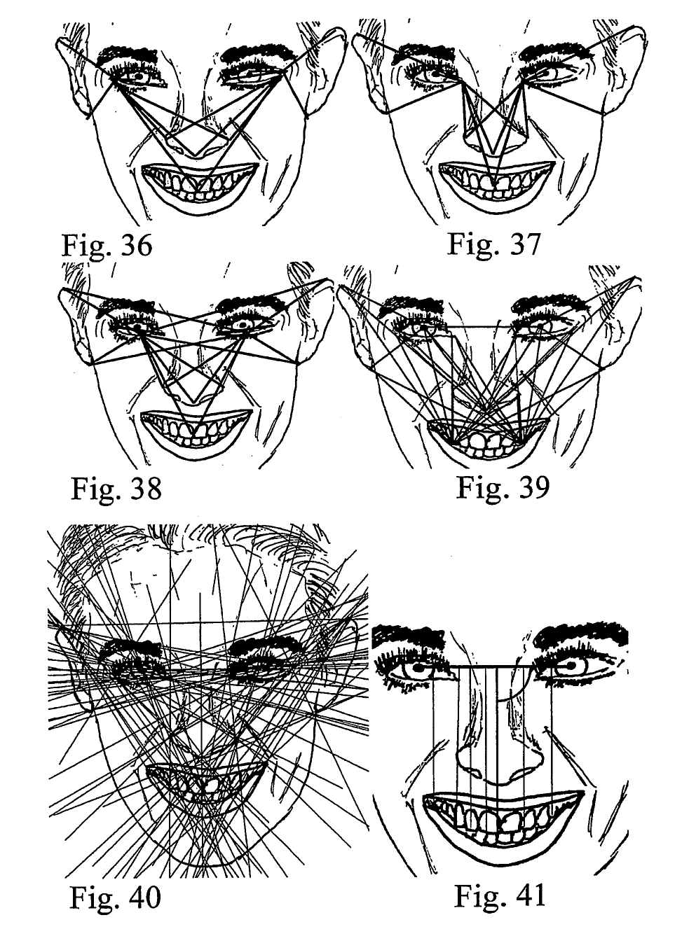

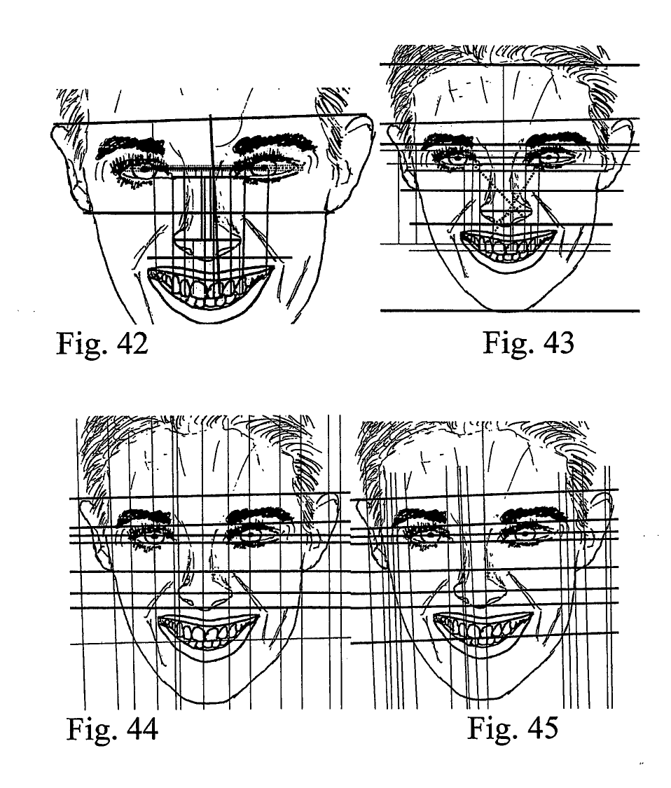

The length and relation of the bipupillary line (connecting line between the two pupils) relative to points and/or lines (e.g., incisal edges and/or other tooth features), the relation of nose tip to tooth features, the distance or relation of one or more points of the face (e.g., lower or upper orbital edge, etc.) to one or more tooth features. In this case, use can be made of the program-prescribed length for the perpendicular (see FIG. 41 for an example, with distance differences on FIG. 42), for the shortest connecting line or the longest and/or a defined line stipulated by points, along with corresponding relations, angles, surfaces, spaces and/or patterns. Several distinct points of the face are marked by arrows on FIG. 29. They and/or their relation to each other and/or to the dentition and the resultant lines, angles, surfaces and spaces can be used for procedural variants described in the claims. FIGS. 30, 31, 35, 36, 37, 38 and 39 present a few selected variants. These lines have been lengthened on FIG. 40, providing additional information. Also obtained are additional intersecting points with the image edge, additional lines, angles, surfaces and spaces, which can used as well. Intersecting points with an image and/or acquisition section edge or with one or more specifically arranged vertical-horizontal lines and/or grid lines have an information content. For example, acquiring bright and dark (line intersection corresponds to a dark point, for example) and/or acquiring intersecting points and/or a relation between intersecting points on a line in this way yields another variant in the claims that differs from the formation of data foundations.

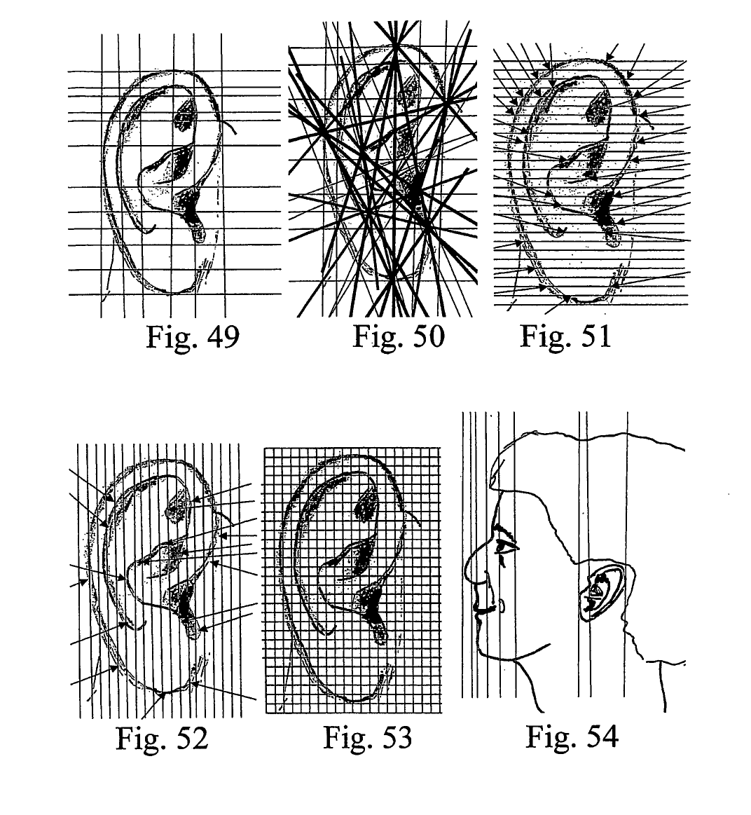

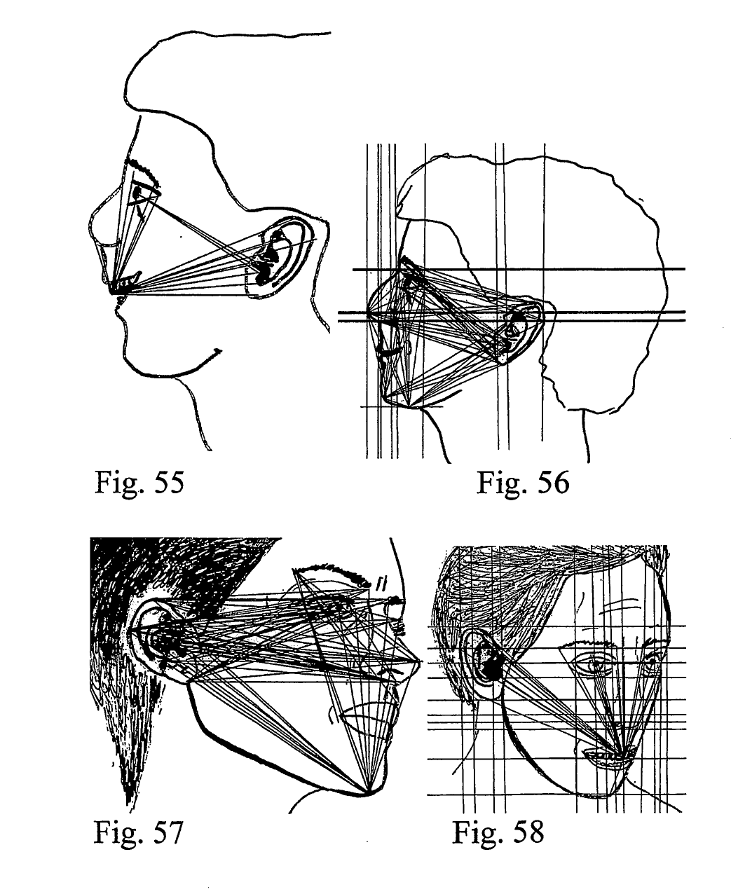

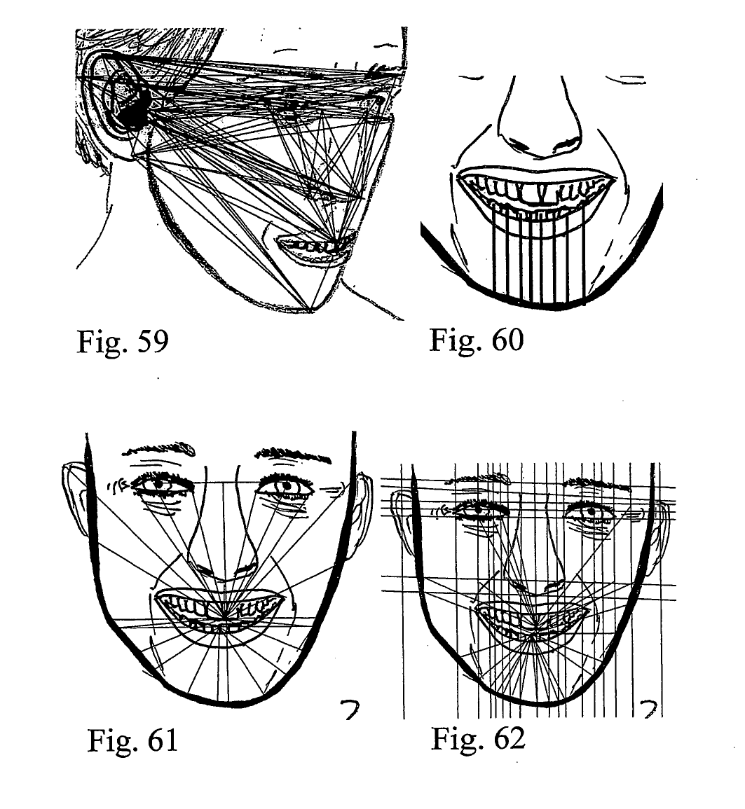

The ear (FIG. 47) contains the triangular fossa (1), antihelical crura (2), anterior notch (3), tragus (4), conchal cavity (5), intertragal notch (6), auricular lobe (11), antitragus (12), antihelix (13), helix (14), scapha (15) and conchal cymba and helical crus below the antihelical crura and above the conchal cavity as examples for the identification and/or verification of useful structures. A few selected exemplary arrows on FIG. 48 point to areas or points, all or part of which are utilized for the aforementioned purpose in the procedural variants described in the claims. The statements made above also apply when using horizontal lines, vertical lines, connecting lines, constructed lines, grids individually or fabricated, etc. For example, see FIGS. 49, 50, 51, 52 and 53. As evident from FIGS. 54, 55, 56, 57, 58 and 59, features, constructed points, distinct points, connecting lines, constructed lines, angles, surfaces and spaces can also be useful or made useful from other perspectives. A line can be formed using distinct or defined tooth points based on a perpendicular, and also at selected angles that were defined and/or program selected. Intersecting lines with structures, natural lines or constructed lines also yield intersecting points, which can be further used as well. FIGS. 60, 61 and 62 present selected examples thereof. The same can also be done with all other distinct and/or constructed and/or defined points. Basically all naturally prescribed, distinct points and/or intersecting points and/or points constructed as defined and/or features of the body, head, face and/or dentition and/or parts in their relation go each other in the pattern that they can form and/or the relation to the environment and in space can be used for identification and/or verification, and can be interconnected.

In addition, all of these connections, constructed lines and/or natural structural lines in relation to each other and to the environment and in space, along with the pattern they form, can be used for the sample purpose, and the angles, surfaces and/or spaces, patterns they generate can be drawn upon for collecting data or acquiring data and/or information for identification and/or verification, and for constructing new, usable intersecting points.

All points, lines, angles and/or surfaces, or at least two thereof, are related with and among each other, and/or form a pattern. The relations and/or patterns can be used individually and as specified in the claims, and/or can be used for data collection.

The individual drawings or figures represent examples, and indeed depict only examples for several of the countless ways in which dentition, teeth, etc. can be used for identification, and the parts and individual elements within the drawings and figures only represent selected examples that serve to illustrate, i.e., can be enhanced and/or replaced by others, which are also to fall under the protection of this application.

It is understood that the above statements regarding the points, lines, angles, surfaces, planes, spaces and structures, features, etc., only serve to illustrate the application. Other models, structures, features, distinct or constructed points, etc., can be readily defined, designed or discovered by experts, and embody the principles of a section of the invention described in this application, and hence fall within the protective scope thereof. Information and/or data can be derived from the above statements, and used for purposes of identification and verification, whether directly or through further processing, possibly even encoding.

Smiling exposes at least 8 teeth for the aforementioned purpose, laughing even more teeth. Owing just to the linear feature and angle and surface combinations, this yields a probability of correlation measuring 1:10¹⁰⁰.

In particular when using laser scans and/or cameras and/or image acquisition and/or processing. however, the probability that two identical teeth will be obtained from different individuals varies depending on the number of measured points, e.g., 720 billion pixels in a one-second scan, wherein each pixel is related to each pixel at 1:infinity-1. The dentition detection contains at least 100,000 feature points, possibly with additional subpoints.

For example, the acquisition of tooth shape, outline, circumference, volume, contour, size, form, partial form, structure, crown curvature, radius, tooth position, dentition characteristics, misaligned teeth (tilted, inclined, rotated, gapped, missing teeth, etc.), presence of teeth, distance, arrangement, number, inclination, height, width, edge progressions, relations, conditions, tooth cross section, abnormal shapes, teeth overlapping with the counter-teeth in the jaw, relation between upper jaw to lower jaw teeth, tooth size, size of interdental space, form and shape of dental arch, stages between the incisal edges, etc., can also be performed both on artificial and/or natural dentitions, teeth, individual teeth, tooth sections, gums, etc., and/or parts thereof. The acquisitions mentioned previously and hereinafter in the text can take place using a laser and/or camera and/or sensor and/or detector and/or image acquisition, etc., via contact and/or non-contact (without contact), etc., with or without lighting.

In addition, all acquisition possibilities (e.g., laser, camera, sensor, image acquisition, etc.) can be used to establish associations and relations between data for the remaining body and/or one or more personal features and a tooth (section), the teeth and/or the dentition.

Even a change in half or three-fourths of the dentition front, or more typically extractions or tooth replacement, etc., could be classified as tolerable given such probability conditions, and the remaining teeth could further be used for identification and verification. The identification/verification can even be performed on one tooth or even a section thereof with a high degree of accuracy. For this reason, it would also be entirely sufficient to only utilize a portion of the data, or to compress or integrate these data, not least to prevent a data flood.

In another logical procedural variant proposed to prevent data floods, the features exclusively characterizing the living being or person, i.e., the special characteristics that only the latter has are acquired and/or newly acquired and/or compared as reference data and/or newly acquired data for identification and/or verification. Special characteristics like these can help select reference data in accordance to the aforementioned identification features, and thereby be used by the search system.

For example, data can be compressed by compiling data.

Another procedural variant describes a color processing and/or determination process using a comparable target for data preselection from the reference data, not least owing to the data volume, which is rising with the increasing use of identification methods and/or verification methods.

For example, just the conventional iris scan can be performed, either enhanced and/or combined with a color camera with color processing or detection and/or using a color camera, in order to acquire the colors and arrive at a color preselection in this way. This color preselection accelerates the selection of iris data allocated to the iris features, and represents a variant described in the claims. The same holds true for other body colors, e.g., skin, teeth, face, etc. The color data for the iris and/or teeth, etc., can also be used during the data selection of data obtained through other means, e.g., facial recognition, finger recognition, voice recognition, etc.

Colors can also be acquired by means of color measuring devices and/or sensors and/or detectors and/or via camera and/or image acquisition with or without lighting the surface drawn upon for identification or verification for one or more of the claims and/or for color acquisition.

Color acquisition combination and utilization with one or more of the patent claims represents a variant described in the claims. For example, the iris color and/or another body color (hair, skin, etc.) can be allocated to tooth form data, which are subsequently also preselected by the color and/or drawn upon for identification and/or verification, or tooth colors are utilized for preselecting iris data or body form data or facial feature data, etc.

Color data for the same or different feature can also encode form data, for example, contain information about the above and/or be representative for the above, and also encode data concerning the form, the outline of a feature or another, and/or contain information about the above and/or be representative for the above. In this way, form data for tooth features can be compared with form features of the face or another body part, e.g., via transposition, and thereby be used for identification and/or verification purposes.

The aforementioned also applies to inanimate objects, items, etc., according to the patent.

If the latter are handmade, the individuality with respect to the form of the scope, outline, features, color, etc., understandably lies in the individuality inherent in how the work was performed by hand or with tools (e.g., artwork, etc.), which depends on aspects like form on the day, emotionality, formative intent, etc., of the creator. But even in factory-made, fabricated products, a product unit has individuality, as variation features distinguish it even from another of the same type, which can be identified and/or verified without a doubt via the latter variation features by means or with assistance the correspondingly mentioned methods using the corresponding means specified above.

In addition, based on the outline not just of persons, but also car makes, aircraft, ships, bombs or mines, firefighting equipment or highly specific objects, which during reference acquisition were individually named, characterized or documented with information or only with a code, the distances can be identified, verified, recognized or detected again using their form, outline, etc.

For example, persons, living beings, items, objects, etc. can also embody or include a feature, object, marking, etc., and/or carry it with them, have it affixed to them, or contain it, wherein the latter can be identified and/or verified at a greater distance, e.g., for this living being/person and/or object, item, in particular via laser-based and/or camera, sensor, detector-based, image acquisition or data acquisition methods. The same holds true for data acquisition, e.g., exclusively via image acquisition and/or camera and/or sensor and/or detector, etc. For example, in military applications, friend and foe can be told apart, individual persons can be identified or verified, and bombs or mines can be recognized based on their marking or overall form. The license plate or marking on a motor vehicle, for example, allows it to be recognized, and hence pinpoint its owner. According to the claims, placement of these acquisition means along a highway or motorway, a tunnel or on bridges at the entry and exit points to these stretches of road makes it possible to monitor usage and determine extent of usage of these structures, e.g., for computing and levying taxes, and helps to determine toll charges. If a completely scanned and/or acquired feature, e.g., a license plate, is scanned and/or acquired again in the form of reference data, it is here also enough to perform a partial scan or acquisition, e.g., on a line, line segment, section of the license plate, which is subsequently converted into data and brought in line. For example, if the license plate is transversely (horizontally) scanned, the line is at a specific height, and acquires data like a bar code, which is then compared with the reference data. However, the feature can also be measured in all other directions. This type of system is advantageous, as motor vehicles do not absolutely have to be equipped with a transceiver, e.g., based on toll systems using GPS or radio waves, thereby making the system autonomous on the ground and independent of international satellites, and secured against manipulation owing to the lack of access by the driver to the system. However, a combination with other systems (e.g., GPS, radio waves, etc.) is also possible. This type of system consists of light transmitters and receivers, along with a data generation and processing system. Such a light transmitter/receiver is set up at each entry and exit point, e.g., of toll highways, or in close proximity to toll tunnels or bridges. The processor can be physically and/or locally separated from this acquisition system, e.g., centralized and/or decentralized, with parts in area of the acquisition system, wherein the patent leaves open the matter of how the data generating and processing units are allocated, so that this can take place at any point of the data acquisition and processing level downstream from the sensor.

No surface is identical to another, and no section of a surface is identical to another in areas no longer visible to the naked eye of humans, even if various points give a visually identical impression given a surface involving two objects of the same name, type or batch, or even the same object. Even surface sections previously acquired in the form of reference data and possibly provided with a label, information, code, etc., can be identified or verified after another data acquisition step and corresponding data association within the tolerance range. For example, the same holds true for objects, items, materials, substances, etc. The highly variable micro relief, surface roughness variation, variation in form of the positive or negative section of this relief, etc., are characteristic to the point where they can be drawn upon in particular for laser-based identification and/or verification. Another variant in the patent describes artificial marking as an object-specific designation (e.g., engraving, laser-assisted marking, etc.) for identification or verification. The designation can contain a code, information about the product, etc.

One marking variant described in the claims can be invisible or visible to the naked eye of an uninitiated person, who hence unable or able to understand or identify the content. The goal of this type of designation or marking is to confirm the authenticity of the document and/or identify or verify its bearer in a manner consistent with the claims.

The reference data for the method according to the claims need not necessarily be stored in a central file or, for example, a portable storage unit carried by the person to be verified, e.g., chip card, transponder, diskette, chip, etc., but rather can be measured via markings, images, etc., in the identification/verification case. For example, an image, impression, positive or negative relief, etc., of the tooth/dentition on an ID or passport or the like can be scanned and/or acquired, and compared with the acquired data for the person, living being and/or individual to be identified and/or verified. In this way, depending on the sequence of acquisitions in this case, the dental image of the ID provides the reference for the scan data or acquisition data for the teeth, e.g., for the person, or the teeth as a personal feature, acquired from the person, forming the reference data for the dentition image on the ID. The same may be done with the body, head, parts of the head, face, etc. Markings also include an image of a fingerprint or face, etc., which also is acquired during verification in order to acquire one or more personal features of the living model. In this identification or verification variant according to the claims, the acquisition of one or more features, e.g., on the ID, identity card, etc., comprises the model reference for the feature to be acquired and/or the feature of the person and/or living being and/or individual drawn upon for verification purposes comprises the model reference for the data in the ID, passport, etc.

The model data can be acquired either with the same system, or with another type of system. For example, the acquisition for model data can take place via a camera system, e.g., with the passport, ID, chip card, etc., and the real structure and/or the real feature, e.g., dentition, face, etc., is acquired with a laser system or vice versa, etc.

According to the claims, the data can be linked with other data to representatively encode one and/or more features, e.g., in the ID, passport, or features on the latter, etc., or one or more features of the person, and verification can be realized by scanning and/or acquiring the corresponding feature. For example, a facial image on the ID can encode tooth features, iris features, head, body features, personal data, etc., of the person/living being, or the iris and/or fingerprint on the image can encode a verification performed via tooth scan on the person, and enable an identification and/or verification, e.g., by comparing the iris on the ID with the tooth acquisition data, and comparing the face on the ID with the acquisition data of the fingerprint, etc. For example, the iris image on the ID and the dentition of the person can be acquired in this way, thereby identifying and/or verifying the person.

Reference data are selected from the database and/or the acquired data, partial data or data segments are harmonized with the reference data or parts or a portion thereof by entering a code and/or using the newly acquired data and/or partial data and/or data segments and/or data on one of the data carriers carried by the person/living being to be identified/verified. Another variant of the identification and verification method is based on the above.

Reference data can also be located in a database, selected form the latter through code input or renewed data acquisition, and drawn upon for comparison with the newly acquired data. However, reference data can also be stored on a data carrier carried by or belonging to the person (e.g., memory chip, transponder, diskette, etc.) or imaged or relief-forming (dental lamina, face, ear, fingerprint, body shape, etc.) or encoded (e.g., bar code, letters, numerical code, etc.). This portable data carrier can be a personal ID, visa, chip card, access authorization card, etc. The subject to be identified and/or verified can also input a code or password, for example, and have their data acquired in the same process. The code selects the reference data necessary for comparison with the newly acquired data.

Finally, the dental image, e.g., on the ID, passport, chip card, can also be compared with the real dentition and/or teeth and/or tooth segments of the person to be identified and/or verified, by acquiring both the image and/or photos and/or relief and the dentition and/or teeth and/or tooth segments of the person.

Several acquisition processes can be combined here. For example, the reference data can stem from a laser scan, and the acquisition of data for the identification or verification can involve a conventional camera scan or be enhanced. The reverse is also true, as camera images can supply the reference data pool, and data acquisition can take place within the identification or verification process using a laser scan. Several procedures can also run parallel or in sequence, yielding data for the reference data and/or enabling data acquisition for purposes of identification or verification, also helping go further to satisfy the human need for safety. The data or partial data and/or data segments thereof derived from at least two different acquisition methods and/or acquisition systems can be used separately or interlinked.

To increase the precision of the method and minimize malfunctions, and also to optimize recognition, it is proposed that a neuronal network (modular computing models based on the biological model principle with the ability to learn) be used, forming the basis for a variant described in the claims. According to the above, the system is intended to optimize the recognition path for itself just based on individual parameters. The neuronal network is also to be used for color evaluation and identification in general, and in particular on teeth.

The reference data and/or information for the corresponding identification feature(s) can be kept centrally in a database, for example, or decentralized on a “data memory” carried by the person to be identified or verified, e.g., chip card, diskette, transponder, storage media, impressions, images, paper, film, in written form, cryptically, on objects, as a contour, in terms of volume, as an outline and the like. Therefore, if the topic involves acquiring and/or recording and/or storing data, this can hence take place via any conceivable and/or previously known capability, and is covered in the claims.

Since all electromagnetic rays obey the general physical laws (beam propagation, refraction, bending, absorption, transmission, reflection, interaction with materials, etc.), but vary in terms of their wavelength, the corresponding system comprised of at least one system element that emits corresponding electromagnetic radiation and a system element that acquires and uses the latter, e.g., a material, object, living being and/or a person, etc., can be used to identify and/or verify what and/or who was exposed to this radiation based on the rays that were detected and altered by the material, object, living being and/or person, etc. Ray patterns, radiation intensities, ray location and ray paths are usable. If radiation is acquired via several detectors and/or sensors, information can be obtained about the ray angle and its change after interacting, for example, with the material, object, living being, person, etc. Energy-richer radiation penetrates through the object more easily, while energy-poorer radiation is reabsorbed or reflected, or scattered more intensely. Intensities, ray path changes, etc., generate ray patterns, and hence data, that can be used for identification and/or verification. In human applications and when using energy-rich radiation, the corresponding x-ray protection requirements and provisions apply. According to the claims, the entire electromagnetic spectrum and/or parts and/or a section thereof and/or only one ray sort with one wavelength can theoretically be used for identification and/or verification. For example, packages of objects can be identified in the same way as materials, objects and/or persons, etc. In this way, the volume, circumference, geometry, identification features involving the pulp (“nerve of the tooth” in colloquial speech) or a part thereof of one or more teeth can be acquired and used for the corresponding identification and/or verification purposes. In addition to the pulp, use can also be made of the individual dentin layer thickness and melt layer thickness, its surface in cross section, its volume in 3D space, and also 2D (e.g., via the surface area of the X-ray image) or 3D (e.g., MRT, CT), and the resultant data can be utilized for identification and verification. Also usable according to the claims are individual geometry, form, appearance, “identification features” of roots, structures of the remaining body not openly accessible or examinable (e.g., (facial) bones, arteries, nerves, spongiosa bars of the bone, thickness of bone corticalis, geometry or parts thereof for the skeleton, etc.).

One or more of these methods are also used for identification in the area of criminal forensics. Convention identifications especially in this area, e.g., for corpse identification, are performed based on models and X-rays kept on file at the dentist. One problem involves the 10-year filing obligation. In particular in persons who rarely visit the dentist, documents like these that could be used for identification no longer exist. This problem could be solved by central data storage in the form of a database for the data acquired according to the procedure.

Works of art, images, paintings, skeletons, bones, valuable stones, e.g., world-famous jewels, etc., can also be acquired in the data in the procedure according to the claims, and then identified or verified at any time during renewed acquisition. Therefore, areas of application include archeology, geology, the art market, and museums.

For example, all of these methods can be used in the area of banks (access to sensitive areas, access authorization to the vault, automated teller, cashless payments, access control, cash dispensers), safety-relevant facilities (e.g., manufacturing facilities, factories, airports, customs) as well as safety-relevant machines and vehicles (cars, trucks, airplanes, ships, construction machinery, cable cars, lifts, etc.). They also allow the identification of payment means (e.g., chip cards, credit cards, cash, coin, stamps) and documents, ID's, passports, chip cards, etc., as well as garbage, e.g., for purposes of sorting refuse at recycling facilities. Military or civilian applications are also possible for detecting or recognizing items, objects or persons that are missing or located nearby.

Other examples of areas that can make use of one or more of the methods described in the claims include the banking sector, computer safety, e-commerce, law and public safety, officials, companies, health care, telecommunications, private sector, device access control, etc. The list of applications and potential uses could be continued virtually indefinitely.

If portable equipment is also used with wireless data exchange and/or processing, official police recognition measures could be implemented directly at the crime scene during identification and/or verification, for example.

Applications and branches that could potentially utilize these methods could go on forever, wherein many possible areas of use and potential applications relating to previously known authentication methods may be gleaned from the relevant literature, and serve as examples for the method according to the invention here as well.

For purposes of objective color description, the color measurement has previously been performed using various systems in the quality control industry and materials research. These devices and systems (e.g., spectral photometer, three-point measuring devices, color sensors, color detectors, etc. and the like) are conceived for measurement on a flat surface and homogeneous materials, like plastics, car paints, publications, and textiles. They sometimes generate a standardized light, which is aimed at the object whose color is being evaluated. This object reflects the light that it does not absorb in the corresponding spectral composition, which must hit the sensor capable of measuring equipment detection for purposes of measurement. The light incident upon the sensor is then processed, for example by hitting photocells, converted first into electrical signals, and lastly into digital signal. For example, the digital signals can be used to calculate measured color numbers and values, values for generating spectral curves, etc. Each level of processing downstream from the sensor yields usable data, partial data or data segments.

At this juncture, it makes sense to draw upon the as-yet unpublished studies with six measuring devices and more than 100,000 acquired and evaluated values of the patent applicant. According to the latter, significant differences are determined between the visually evaluated comparison templates routinely used in dental practice, so-called color tooth rings, and the tooth color actually measured. In addition, these templates are used to visually evaluate natural teeth that were assessed as having the same color in a completely different manner in terms of measurement techniques, and no tooth had to exhibit even remotely similar measurement results relative to another. Both the influence of tooth crown curvature and the inner tooth structure were viewed in isolation, and contribute to the variety of calorimetric values indicated above, among other things.

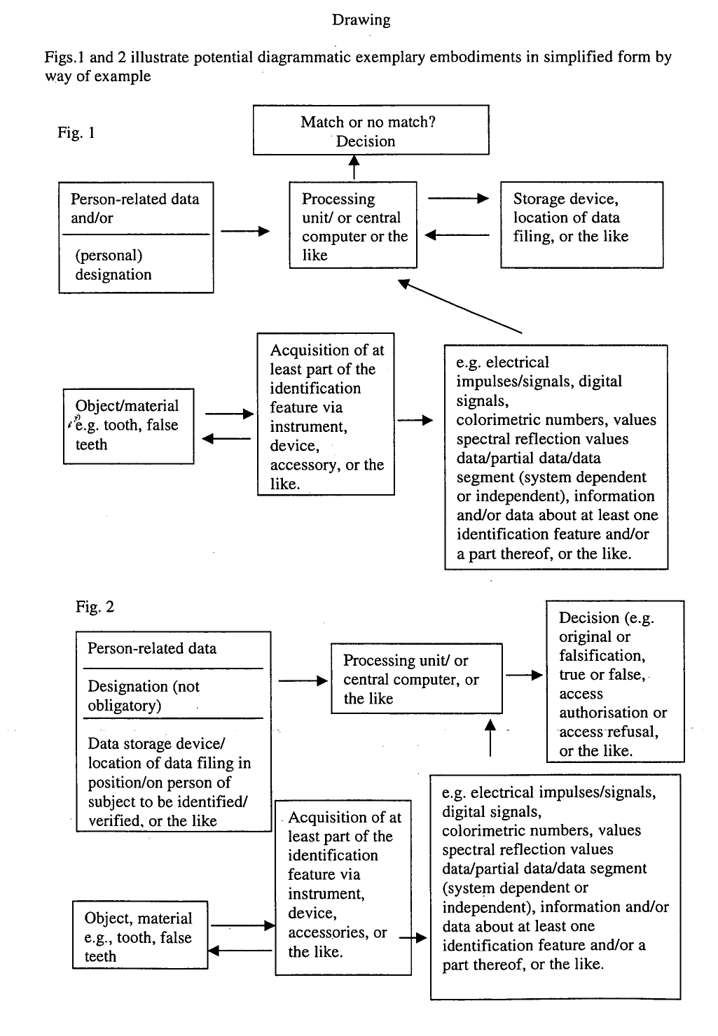

In other words, the measuring results are significantly impacted by the exceedingly individual outer structure of the natural tooth in terms of tooth geometry, its crown/root curvature and uniqueness of the inner structure, e.g., its coated structure (enamel, dentin, pulp, relations and variations in layer thickness), its individual crystal structure, individuality of alignment, form and density of nanometer-sized prisms individually grown in the development phase, lattice defects in the crystal structure, the individual size and share of organic and inorganic material, the composition and chemical makeup of these shares, etc. The aforementioned yields the most complex refraction, reflection, remission and transmission processes, which affect the measuring results and data. The reflected, unabsorbed light with a new spectral composition determines the measuring results and/or data (e.g., colorimetric values per CIELAB, CIELCH 1976, Munsell system, etc., color measured values, values for describing a spectral curve, information content, and other data, etc.). These measuring results on inhomogeneous, intrinsically structured natural teeth have no similarities with the measurements performed on flat, homogeneous synthetic materials. Passages of the claims or specification that refer to reflected or mirrored light always encompass the color, color term or spectral composition of the light hitting the sensor as well, with the same holding true in reverse with respect to teeth, where the same applies to tooth sections or several teeth and/or dentitions. With respect to the data or partial data mentioned in the claims or specification, the same course of action would in each case be possible using only one data segment or one datum or part thereof. This notwithstanding, it would be advisable from a theoretical and mathematical standpoint relative to probability to use more rather than less data for the methods described in the claims. Whether larger or smaller amounts of data are needed for these purposes depends heavily on the safety interests of the user or person utilizing these methods, among other things. The mirrored light mentioned above is created, hits light generated by a light transmitter (e.g., artificial and/or near natural and/or or standard light, device intrinsic or room light fixtures, artificial light, etc.) and/or the natural light (e.g., sunlight, daylight) on the tooth, which in turn alters the light owning to its exceedingly individual inner and outer structure, and reflects the altered light. The light mirrored by the tooth contains indirect information about the tooth interior, and about its outer structure. This inner and outer structure of a tooth and the light it reflects is at least as unique as a fingerprint, DNA (gene code) or iris, and hence as unique as a human or individual. The reflected light absorbed by a sensor, detector, photocell, camera, image acquisition device, etc., is converted into a data record or partial data record. Each data record or partial data record contains information about the light reflected by the tooth, which has its roots in the tooth color and individual structure intrinsic to the tooth. These data also contain encoded information, e.g., about the color, structure and makeup of the tooth. As a result, these data or partial data are just as unique as the grown, natural tooth of a human or individual. This makes it possible to identify teeth. The natural owner of the tooth is linked to this information, and can be identified with it. Once stored, archived or filed, these data or partial data obtained from the light reflected by the tooth can be used as a pattern when again acquiring or partially acquiring the reflected light detected by the sensor with the resultant data or partial data for identifying or verifying teeth, persons or individuals. The exemplary drawings on FIGS. 1 and 2 provide information about this. If the data or partial data generated from a renewed acquisition of the light reflected by the tooth essentially match the stored, archived or filed data/partial data, or approximate them, or if similar result templates exist, the tooth is identical to the one stored, archived or filed in the data previously. Given the absence or inadequacy of a match or approximation of data, partial data or result templates, the tooth is not the same one. The same holds true for the identification of persons or individuals who are the natural owner of the natural tooth used for identification. If the match or approximation between data, partial data or result templates obtained from the light reflected form the model (model tooth) and the results of renewed (tooth) acquisition is sufficient, this person or individual who was subjected to renewed acquisition is identical to the person or individual from the model acquisition. The advantage to image acquisition (e.g., laser scan, camera, video camera, digital, analog camera, photo camera, photo scanner, etc.) at least for identifying and/or verifying a subject body and/or dentition and/or area and/or section and/or an identification feature and/or parts thereof, and in particular relative to teeth, is providing the opportunity to limit and/or select the section(s), point(s) to be used in terms of color, pattern, relation, form, etc., and/or one correspondingly located on the identification feature(s) and/or the area(s) to be used via adjustment in terms of size, localization, form and its number, patterns, etc. (e.g., factory settings, user settings, the authorizing party, image processing, etc.), wherein this makes it more difficult for unauthorized persons to outsmart the system, since they cannot known exactly where they would have to take simulative or manipulative action to overcome the system. The same holds true for the acquisition of all identification features, e.g., including those for form and shape acquisition. A visually subjective acquisition or evaluation or comparison of “identification features” based on (previously) individually fabricated and/or manufactured patterns or samples (form templates, dental color templates, comparison patterns, etc.) as performed by an evaluator would also be a variant encompassed by the claims, and also represent a cost-effective aid.

In addition, due to the highly individual manual capabilities and sensitivities in terms of aesthetics, color and forms, as well as the adjustment to natural, exceedingly individual circumstances, the craft of dentists or dental technicians holds out the promise of a high level of individuality in color, form, layer thickness, etc., for tooth replacement and prosthetics as well, which here also allows the identification of the work performed, and the person or the individual as the owner of this work. Therefore, a tooth or teeth represent not just natural, but also false, non-natural teeth. Artificial or non-natural teeth reflect the results of work performed by dentists or dental technicians, or represent objects owned by the patient in the form of teeth/tooth sections or to perform functions of teeth/tooth sections, which are or can be worn in the mouth of the patient (e.g., fillings, caps, inlays, prostheses, etc.).

The person or individual is identified based on the working result and/or object drawn upon for purposes of identification, which each person or individual owns or carries. Given a sufficient match or approximation of data, partial data or result templates obtained from the reflected light or acquisition of at least one identification feature(s) or parts thereof from the model (artificial teeth/tooth, working result or object, etc.) and its renewed acquisition, this person or individual being subjected to renewed acquisition is identical to the person or individual who underwent the model acquisition. The use of these methods in forensics makes it possible to allocate tooth material to the tooth material belong to the same individual and to the very individual. The identification of dead persons will be another objective of this method. Teeth of the same individual exhibit matches or approximations of data in the data records determined as specified in the claims. Another application would involve archeology. If the data records or partial data records for one and the same tooth or the same teeth from the same person or individual are compared, living or dead persons or individuals can be clearly identified in the area of forensic or criminal investigations. In this conjunction, it would also be conceivable to have a pool of data relating to corresponding dental data records, as generated using as many living persons as possible. This makes it possible to clearly perform, accelerate and facilitate the identification of dead persons. Other areas include checking of access authorization, e.g., for safety-relevant facilities and areas, bank accounts, control of persons or individuals crossing borders, identification and allocation of persons or individuals to a group, community or country.

These data records or partial data records in conjunction with ID's, passports, driver's licenses, access authorizations, make it possible to identify the person or individual. The banking and savings industry, safety-relevant facilities (factories, manufacturing facilities, airports, aircraft, etc.), forensics, criminal investigations, etc. represent potential uses for this method.

One significant advantage to using the light reflected by teeth for identification and verification is that teeth, in particular the front teeth, remain structurally intact over long periods of time. The inner and outer structure of permanent teeth in grownups are not subjected to any changes. Changes stemming from caries, erosion, dental procedures, are becoming increasingly less important in the younger generations owing to modern dental preventative measures, and even alterations in an individual tooth introduced by a dentist can be recorded by updating the data record through simple data acquisition after an operation on the tooth structure. Verification: The new input data or partial data obtained from the reflected light are compared with the already stored data or partial data from the corresponding process for data collection described in claim 1 and/or claim 2. In order to harmonize these data or partial data from the data storage device or database with the data or partial data of a current acquisition after the procedure, the user or person or individual requests a personal code, identification, data disclosure or the like (e.g., code number, other personal code on a data carrier, data and/or the like). If the data or partial data in the database or data storage device selected via code, identification or data disclosure match the data or partial data from the current acquisition process, the person is who he/she claims to be, and his/her identity is confirmed. Data storage devices can also refer to the location or any specific type of filing or recording of these data. FIG. 2 shows a procedural example, in which selection of the data or partial data to be compared in the current acquisition process takes place from a central data storage device by way of a code, wherein the comparison data in the form of a portable data carrier or one owned by the person or individual to be verified are available during verification for comparison with the data or partial data determined in the current acquisition process. An additional code would not be absolutely necessary in this case, but possible. The methods in combination with chip cards, ID's, passports, driver's licenses, etc., have a great variety of potential applications.

In this way, the development of tooth-specific, personal, private identification features can satisfy the demand for more security in banking, access-authorization requiring safety-relevant equipment, factories, manufacturing facilities, and airports, and enhance the previously existing methods in the field of biometrics with new methodologies or a new procedure and new capabilities in this area. These data records or partial data records when combined with ID's, passports, driver's licenses, access authorizations make it possible to biometrically identify, verify, detect and recognize the person or individual. The banking and savings industry, safety-relevant equipment (factories, manufacturing facilities, airports, aircraft, etc.), forensics, criminal investigations, etc. are potential uses for these methods.

Providing the acquired data/partial data (based on the above claims) for materials with a code (e.g., bar code, code number, data/partial data, material description, etc.) enables utilization for detection, recognition, identification and verification of corresponding materials, items, objects, colors, etc., e.g., for optimizing and monitoring production processes, in logistics, customs and criminology, etc. The data, partial data or data segments acquired as described in the claims can also be provided with information about the material or product, either directly or indirectly by way of a code. The applications and advantages are described in the aforementioned claims. Rapid access to information is also possible, and there is a high level of security with respect to falsification. None of the methods according to the invention are limited in terms of locality, arrangement, number and connection of procedural steps, portions or constituents, or with respect to the (technical) means used for this purpose. In addition, the method according to the invention is not limited in any way with respect to the type, selection, quantity and number of means for realizing the data processing/comparing steps, as well as the data used. The universal application of this method must hence be regarded as an additional advantage.

It goes without saying that, given the large, almost incalculable variety of equipment, instruments, systems and/or accessories and their various names and designations, which also exist already for general purposes, in particular for the acquisition of form, partial form, shape, contour, outline, volume, features, color, relations, peculiarities, of the reflected light, electromagnetic radiation, their patterns, their spectral composition, their ray path, of reflection and/or transmission, only a partial, exemplary list can be presented in view of the limitation of scope of this patent application, so that, for this reason, in addition to the examples listed, e.g., CCD (charge coupled devices), ICCD (intensified charge coupled devices), EMCCD (electron multiplaying charge coupled devices), CMOS-detector, camera, sensor, line, video camera, color camera, image processing, image acquisition, NIR (near infrared) camera (wavelength 900-1700 nm), IR (infrared) camera, CCM coordinate measuring machine, CAD-CAM system, photodetector, black-and-white or color (image) camera, in moving or stationary images, UV light camera, spectral photometer, color sensors, detectors, detectors, three-point measuring device, photocell, fluorescence spectroscope, microspectrometer, X-ray machine, CT (computer tomography), MRT (magnetic resonance tomography), automatic ID (biometric system), biometric device (biometric recorder, biometric engine (software element, registration, recording, comparison, extraction and match processed), line light topometry (“Streifenlichttopometrie”), CCM-coordinate measuring machine, contactless free-form scanning, etc., the patent claims allow for the selection or enumeration of numerous other potential applications (methods, equipment, instruments, systems and/or accessories) for the corresponding acquisition and/or gathering of data usable for authentication, and/or their combination with the aforementioned, which here can be used or applied for this purpose of (biometric) identification and/or verification, in particular relative to a tooth, tooth sections, teeth and/or dentition and/or a section thereof. When lighting is used, the most varied of means can be employed (e.g., artificial light, daylight, standard light, sunlight, light that allows higher optical and in particular spatial resolution, laser light, LED's, standard light fixtures, fluorescent tubes, incandescent bulbs, etc.). Visually subjective or objective evaluation can also take place using comparative color palettes (e.g., color samples, color palettes, color tooth rings, color match), spectroscopy, etc. All devices or accessories can be used or operated alone or combined per the claims for purposes of identification and/or verification.

In theory, use can be made of all previously known or published instruments, equipment, devices, sensors, detectors, cameras, acquisition units, systems, methods, capabilities, etc., that are suitable and/or used and/or applied and/or described for acquiring data and/or obtaining information from the forms and/or partial forms and/or shape and/or contour and/or volume and/or outline and/or features and/or particularities and/or surface structures (e.g., relief, microrelief, roughness, etc.) and/or outer and/or inner geometries and/or colors and/or structures and/or makeup and/or natural and/or artificial reflected light and/or electromagnetic radiation and/or a portion thereof and/or its spectral composition and/or its ray path, parameters and/or information acquisition, etc., even for use and application as described in the claims for identification and/or verification, especially relative to the dentition, teeth, tooth (segments), etc., so that the latter are encompassed by the scope of protection of this application.

However, given the limited scope of this application, a plurality of additional possible applications will not be enumerated, and their theoretical backgrounds will not be described; reference is instead made to the fact that all ways in which the biometric parameters/bases according to the claims can be acquired for application in particular to teeth (tooth, tooth section, teeth and/or dentition) and/or according to the claims will also be protected by the claims.

In addition, it goes without saying that the (general) modes of operation and/or principles and/or technologies and/or process (execution) and/or capabilities can also be used according to the claims for information and/or data processing and/or procedures, etc. (e.g., acquisition, processing data preparation, data (comparison), etc.), involving previously known (biometric) identification and/or verification methods, e.g., physiological or behavior-based, etc. (e.g., machine or biometric facial, fingerprint, finger, hand geometry recognition, iris, retina acquisition, nail bed, vein pattern, gait, lip movement, voice, signature recognition, sitting, touching behavior, etc.) and or holistic (e.g., acquisition of entire face, eigenface, template matching, deformable template matching, Fourier transformation, etc.) and/or feature-based (e.g., acquisition of individual features, facial metric elastic bunch graph matching, facial geometry) (Amberg, Fischer Röβler, Biometric Processes, 2003, pages 22-25) approach and/or other approaches, etc., (e.g., average value determination from pixels and gray levels, threshold formation, feature extraction, harmonization of print with template, analog or digital data can be used, Hamming distance number of non-corresponding bits between two binary vectors used as the gauge for variability, preprocessing for compensation, positioning of figure template with new recording, feature extraction, average formation, generation of jets and wavelets, vector utilization, Fourier transformation, etc.) and/or parts and/or individual procedural steps, etc., thereof, and can also be sued for authentication in particular based on tooth, tooth section, teeth and/or dentition, together with the surrounding structures, etc., or parts thereof, and/or with the methods described in the claims, and hence are protected by the application as described in the claims in conjunction with the tooth, tooth section, teeth and/or dentition, together with the surrounding structures thereof, etc., or parts thereof, etc. The same holds true for the combination of previously known methods in this area with those in the patent application.

In passages of the specification and claims that refer only to living beings or persons or animals or individuals, it goes without saying that living and/or dead beings and/or persons and/or animals and/or individuals and/or living nature are being referred to.

The claimed protection of this application also extends to any use, whatever the type may be, of dentition, teeth, a tooth, tooth sections and/or parameters, characteristics, information, data, etc., derived and/or obtained from them, with and without combination and/or inclusion of other surrounding (bodily) areas and/or animate and/or inanimate nature for purposes of identification and/or verification of persons, living beings, animals, individuals, etc.

1. A method that utilizes the form and/or partial form and/or shape and/or contour and/or volume and/or outline and/or scope and/or proportion and/or measure and/or size and/or one or several features and/or particularities and/or surface structure (e.g., relief, microrelief, roughness, texture, etc.) and/or outer and/or inner geometry and/or relations and/or color and/or structure and/or setup and/or lamination and/or composition and/or arrangement and/or natural and/or artificial reflected light and/or electromagnetic radiation and/or artificial and/or natural parameters and/or characteristics and/or parts and/or sections hereof and/or the like, etc. (identification features) of natural and/or artificial dentition and/or teeth and/or tooth and/or tooth sections as a feature (dental identification feature), e.g., of living or dead bodies (e.g., persons and/or living beings and/or individuals and/or animals, etc.) and/or inanimate bodies (e.g., items, materials, substances, objects, etc.) and/or at least a part and/or section thereof as a feature (identification feature) for identification and/or for verification and/or authentication of living and/or dead persons and/or living beings and/or individuals and/or living or dead bodies (e.g., persons and/or living beings and/or individuals and/or animals, etc.) and/or inanimate bodies (e.g., items, materials, substances, objects, etc.), and acquires this using a suitable and/or capable device and/or instrument and/or system and/or (accessory) means, wherein:
One or more of the above features and/or identification features and/or a part and/or a section of those is/are detected by a device and/or instrument and/or system and/or means suitable and/or capable for this purpose;
Data and/or partial data and/or data segments that can be applied and/or used for this method purpose are obtained herefrom;
The data and/or partial data and/or data segments acquired in this way are stored and/or filed;
The data and/or partial data and/or data segments and/or data records acquired and stored in this or another way are used for identification and/or verification and/or authentication of a tooth and/or person and/or individual and/or living being and/or dead and/or inanimate body (see above), in that respective newly acquired data and/or partial data and/or data segments are compared with the previously stored or filed data, partial data and/or data segments.

2. (canceled)

3. The method according to claim 1, wherein additional identification features and/or structures and/or areas and/or parts and/or sections hereof in the nearer or remote area of the dentition and/or teeth and/or the tooth and/or tooth section (e.g., body, head, face, ear, nose, eyes, in particular cornea, arm, hand, leg, food, torso, finger, toe, etc., and/or a part and/or a section, area, portion thereof, etc.) are included in the acquisition, processing and/or evaluation of features and/or combined with the latter.

4. The method according to claim 1 for purposes of identifying persons, individuals or living beings based on one or more of the recognition features and/or identification features carried by the latter or affixed to them and shown, wherein the acquisition of the latter takes place by means of suitable devices, instruments, systems and/or accessories (e.g., a laser, camera, etc.).

5. The method, according to claim 1, according to which one or more recognition features and/or identification features can be acquired even at a greater distance of the recognition feature from the location of the acquisition device, instrument, system and/or accessory, and/or one or more features and/or areas of use for identification and/or verification can be magnified.

6. The method according to claim 1, wherein a present person is detected in a specific or prescribed space, or in an area, and/or localized, etc.

7. The method, according to claim 1, which uses the natural features and/or identification features (e.g., body, object, material, product-intrinsic or characteristic structure or relief).

8. The method, according to claim 1, but one that uses artificially generated and/or processed features and/or identification features (e.g., artificially produced relief, e.g., chemically, via lasers, etc.).

9. The method according to claim 1, wherein the identification feature(s) and/or structure(s) and/or feature(s) drawn upon for identification and/or verification can be recognized and/or seen and/or not seen and/or recognized with the naked eye.

10. The method according to claim 1, wherein the identification features and/or feature and/or relief and/or structure, etc., contains and/or has or can have allocated to it, for example, an identifier, a code, information about and/or description, etc., of this person, individual and/or living being, and/or the object and/or material, which is connected with the object or body (part) and/or the artificially generated and/or natural feature, relief and/or structure has allocated to it a code and/or information and/or identifier for identifying or verifying and/or describing this object, material, etc., representing it.

11. The method according to claim 1, wherein the device, instrument, system and/or accessory for acquisition is a correspondingly suitable and/or capable laser and/or a laser system suitable and/or capable for this purpose with at least one light transmitter, and at least, for example, one receiver, sensor, detector, camera, etc. suitable for these purposes, and/or includes the latter.

12. The method according to claim 1, wherein the device, instrument, system and/or accessory used is at least a camera and/or camera system and/or receiver and/or sensor and/or detector and/or acquisition element and/or means capable of image acquisition and/or feature acquisition and/or feature tracing and/or contains at least one of the latter.

13. The method according to claim 1, wherein the information and/or data about the structure that can be used for identification and/or verification and/or the features and/or feature and/or identification drawn upon are obtained and/or acquired and/or processed and/or used in 2D and/or 3D, and/or the information and/or data can be generated in 3D.

14. The method according to claim 1, wherein the acquisitions take place from a perspective and/or from one side and/or from more than one perspective and/or more than one side and/or thereby enable a reconstruction of identification features and/or parts and/or sections thereof in 3D.

15. The method according to claim 1 that enables the acquisition of reference data and/or newly acquired data directly on the original and/or on a negative (e.g., imprint, image, etc.) of the or a copy (e.g., model, etc.) of the identification feature used and/or drawn upon for identification and/or verification, detection or recognition.

16. The method according to claim 1, which utilizes the capability of identification and/or verification by means of a device, instrument, system and/or accessory capable of acquiring the, for example, identification feature, form, shape, contour, outline, surface structure, etc., generating data and/or data segments and/or partial data that can be compared with data and/or data segments and/or partial data obtained from a previously executed acquisition process using another method and/or instrument, system, accessory and/or apparatus for this purpose, wherein:
At least one identification feature (e.g., outer form or partial form, shape, contour and/or outline, etc.) and/or a portion thereof and/or a section thereof is acquired by means of a device, instrument suitable for this purpose and/or a suitable system and/or means, wherein usable data, partial data and/or data segments are generated in this way for this procedural purpose;
The data and/or data segments and/or partial data acquired in this way are stored and/or filed;
The identification data records acquired and stored in this way or another way by comparing newly acquired data, partial data and/or data segments obtained by means of one or another device, instrument also suitable for this purpose, and/or a suitable system and/or means to the previously stored or filed data, partial data or data segments.

17. The method according to claim 1, wherein the data, partial data and/or data segments acquired and stored in this way are used for personal verification and/or living being and/or individual verification by comparing newly acquired data, partial data and/or data segments with data, partial data and/or data segments designated with an additional personal code and already acquired and/or stored and/or filed and/or existing.

18. The method according to claim 1, wherein use is made of the data, partial data and/or data segments acquired and stored and/or filed in this way for personal verification and/or living being and/or individual verification by comparing newly acquired data, partial data and/or data segments for person, individual and/or living being to be verified with the data, partial data and/or data segments designated with an additional personal code and already acquired and/or stored and/or filed and/or existing, which stem from an identical or different acquisition process, and present in the form of data, partial data and/or data segments present in a, for example, data storage device, ID, passport, chip card, etc., e.g., on or in the hand and/or body and/or possession of the person, individual and/or living being to be identified or verified.

19. The method according to claim 1, wherein use is made of the acquired and stored or filed data and/or partial data and/or data segments, e.g., for item, object, material verification, etc., by comparing newly acquired data, partial data and/or data segments with the data, partial data or data segments designed with an additional identifier and already stored and/or filed, and/or by comparing newly acquired data, partial data and/or data segments, e.g., of the item, object and/or material to be verified with the data, partial data/data segment that have already been stored and/or filed and/or exist and/or were designated with an additional identifier, obtained via the same and/or different acquisition method, and physically related to the item, object and/or material to be identified or verified, for example, e.g., in the form of a data storage device and/or surface structuring, etc.

20. The method according to claim 1, wherein at least two difference acquisition capabilities are combined, e.g., laser acquisition is combined with at least camera recording and/or sensor and/or image acquisition, a camera acquisition with detector acquisition and/or some other combination, etc., is used for data acquisition during identification and/or verification, and/or for purposes of reference data acquisition and/or generation, etc.

21. The method according to claim 1, and also according to previously known conventional methods (e.g., facial recognition, finger, iris scan, etc.), wherein the latter is additionally enhanced and/or combined by and/or with upstream and/or downstream and/or simultaneous color acquisition and/or color determination and/or processing and/or image color acquisition and/or acquisition of spectral composition and/or color characteristics and/or reflected light, etc., e.g., relating to (personal) feature(s) and/or identification features and/or areas and/or partial areas usable for identification and/or verification.

22. The method according to claim 1, which enhances and/or combines one or more of the preceding methods with one or more conventional methods (e.g., iris scan, finger scan, facial acquisition, etc.) or enhances one more conventional methods with one ore more of the preceding or following methods.

23. The method according to claim 1, wherein the color acquisition and resultant usable data can be used relative to another material than the one drawn upon for the form, shape, outline and/or surface structure, etc., and/or encode its data and/or represent the latter and/or can be used for reference data selection relative to the latter.

24. The method according to claim 1 for identification and/or verification based on color acquisition and/or color determination and/or processing and/or image color acquisition, acquisition of spectral composition for the color characteristics, etc. (e.g., iris, tooth, skin, hair color, etc.).

25. The method according to claim 1 for acquiring and/or obtaining authentication data, e.g., by means of a color measuring instrument, sensor, detector, spectral photometer, three-point measuring device, laser (system), color measuring equipment, color sensors, image processing, color analysis of image, photo, video, digital, camera, an image recording system, image processing system, image acquisition, camera system, sensor, detector, acquisition of ray path, the acquired spectral composition of reflected light, etc.

26. The method according to claim 1 for color identification through image acquisition and/or color sensors or color acquisition and color processing, in particular and/or for example for dental purposes, comprising:
Image acquisition and/or color sensors and/or color measurement;
Conversion of detected information into data;
Possible processing of information within a neuronal network;
Utilization of these data to obtain information about tooth color, e.g., printed out in the corresponding dental nomenclature and/or in dental product mixture ratios, in calorimetric numbers, etc.

27. The method according to claim 1, in which at least the area or feature section drawn upon for identification or verification is illuminated with at least a radiated power measuring that of daylight at the location of the object to be detected, and when used on a living organism, a radiated power for the light source at the corresponding location of the object or identification feature to be detected measuring less than the maximum permissible radiated power depending on application site, e.g., for the (human) eye or skin and/or at which the radiated power at the feature measures at least that of sunlight, but at most lies below the power damaging to the feature, and/or that the light used to illuminate at least the identification feature lies within the visible spectrum and/or encompasses and/or also encompasses a region and/or several regions of invisible and/or visible light, and/or the light is spectrally limited and/or monochromatic and/or is laser light.

28. The method according to claim 1, wherein, at a maximum of each and/or after n-defined and/or after a timeframe to be stipulated and/or following the last identification and/or verification and/or reference data acquisition, the model and/or reference data are automatically updated, either during the identification or verification process and/or separately via acquisition, which is incorporated into the reference data storage device and/or model filing location if the data are still in the proper procedural framework, i.e., the new data correlates with or lies in the tolerance range of the reference and/or model data and/or the tolerance range can be selected or stipulated depending on the system and accuracy requirement, e.g., based on the safety standard.

29. The method according to claim 1, wherein data from the acquisition of the personal feature are newly acquired according to one or more of the preceding methods, which are wholly or partially used by the search program to find the reference data, with which the newly acquired data, partial data and/or data segments can be compared.

30. The method according to claim 1, wherein use is made of data, partial data and/or data segments from acquisition by means of previously known methods (face, iris, fingerprint, etc.) and/or by means of new methods (e.g., dentition, tooth, tooth section, etc.), as a pin code or password replacement, which can also be utilized by the search program to find the reference data with which the newly acquired data or data segments can be compared, and/or as reference data for the data or data segments of acquisition.

31. The method according to claim 1, comprising the input of a coded and/or supply of the system with data, e.g., from a (portable) data storage device, which the person to be identified or verified carries, for example, so that the search program can more quickly find the reference data with which the newly acquired data are to be compared, and/or as proof that the person being checked is the owner of this data carrier and/or ID and/or passport, etc.

32. The method according to claim 1, which uses identification features, color, parts thereof, etc., and/or data relating thereto as data and/or codes for data selection via the search program for identification and/or verification.

33. The method according to claim 1, used for a toll system.

34. The method according to claim 1, which correlates, for example, the structures, features, regions, etc., with a tooth, teeth or tooth sections, tooth features, etc.

35. The method according to claim 1, which utilizes naturally existing and/or naturally distinct and/or artificially distinct and/or artificially constructed features, points and/or intersecting points and/or particularities and/or their relation to and/or among each other, in particular exclusively on the dentition, tooth, teeth and/or tooth sections in and/or in combination with surrounding identification features (e.g., body, head, face, ear and/or items and/or objects and/or parts thereof, etc.) and/or exclusively on surrounding identification features, e.g., as data and/or as data foundation for identification and/or verification.

36. The method according to claim 1, wherein naturally existing and/or naturally distinct and/or artificially distinct and/or artificially constructed features, points and/or intersecting points, particularities, etc., are detected and/or recognized by the system, and/or can be used for identification and/or verification.

37. The method according to claim 1, wherein at least one point and/or feature and/or particularity of the dentition, teeth, tooth and/or tooth sections forms a relation to the environment, e.g., body, head, face, ear and/or parts thereof, etc., and/or to at least one point and/or feature and/or particularity, and/or that at least two points and/or features and/or particularities form a relation to each other and/or to the environment (points and/or features and/or particularities), which can be used for purposes of identification and/or verification.

38. The method according to claim 1, in which points and/or features and/or particularities, etc., in space and/or in relation to each other are applied as patterns for purposes of identification and/or verification.

39. The method according to claim 1, wherein at least two naturally existing and/or artificially generated distinct points and/or features literally or figuratively are connected, e.g., by the identification and/or verification system, or by the person to be identified or verified, thereby forming an artificial or natural connecting line and/or intersections of connecting lines for additional points (constructed points, intersecting points), which in turn can be connected literally or figuratively (additional constructed connecting lines), so that data can be derived from them.

40. The method according to claim 1, wherein connecting lines, which can also be elongated, can intersect, e.g., with naturally existing structures or structural breaks, changes in continuity, etc., and these intersections (constructed points) also generate data about their relation to each other and/or to the environment and/or other points and/or connected with each other and/or with other points, form lines and produce data that can be used for identification and/verification.

41. The method according to claim 1, wherein all distinct and/or constructed points and/or features and/or intersections, etc., can be connected with each other and/or connected, and their connecting lines can be used for generating data.

42. The method according to claim 1, wherein at least one connecting line between two naturally existing distinct and/or artificially generated constructed points and/or features and/or constructed line and/or a line deliver data about their length.

43. The method according to claim 1, wherein data formation for identification and/or verification is based at least on an angle, surface, plane and/or the space formed by (connecting) lines between points and/or features and/or particularities and/or by points and/or features and/or particularities themselves (e.g., corner points).

44. The method according to claim 1, wherein lengths, angles, surfaces, planes and/or spatial areas can be reconstructed for the identification and/or verification process if the either the distance of the structure to be evaluated or the feature to be evaluated from the acquisition device (e.g., object-lens distance) and/or the angle during reference data acquisition is known.

45. The method according to claim 1, wherein at least one point and/or feature and/or particularity and/or at least one connecting line and/or lines and/or surface and/or surfaces and/or at least one space in space and/or in relation thereto and/or in relation to each other can be used as a pattern usable for identification and/or verification or a correspondingly usable pattern, and/or for information and/or data generation for the aforementioned purpose.

46. The method according to claim 1, wherein intersections between a horizontal line, vertical line and/or grid lying real and/or imagined over the image intersect natural structural lines, continuity changes and/or constructed lines and/or connecting lines, and that these intersections form or can form the basis for generating data or patterns usable for identification and/or verification.

47. The method according to claim 1, wherein the horizontal lines and/or vertical lines are equidistant and/or not equidistant form each other and/or the grid has grid elements of identical and/or different sizes, and/or the distance between horizontal lines and/or vertical lines and/or the size of the grid(s) can be adjusted.

48. The method according to claim 1, wherein the horizontal lines and/or vertical lines and/or grids are individually formed by the distinct points, natural features, artificially constructed points, and thus represent an individual pattern that can be used for purposes of identification and/or verification.

49. The method according to claim 1, wherein the feature-based, individual horizontal lines and/or the vertical lines and/or the individual grid and/or constructed lines intersect the edge, e.g., of the image section and/or intersect defined, prescribed lines and/or planes, and that these intersections comprise an individual pattern that can be used for purposes of identification and/or verification.

50. The method according to claim 1, wherein the horizontal lines and/or vertical lines and/or grid are and/or become oriented individually to at least one point, feature and/or particularity, and are aligned and/or become aligned and/or can become aligned relative thereto, wherein at least the point, feature and/or particularity lies in particular in the area of the dentition, tooth, tooth section or in the area of the remaining body, head, face, etc.

51. The method according to claim 1, wherein at least one additional point and/or one additional feature and/or particularity lies in the area of the face and/or in the are of the remaining body and/or that at least such a point and/or such a feature lies in the area of the tooth and/or dentition, and at least one other one in the area of the remaining body, head and/or face.

52. The method according to claim 1, in which the relationship between at least one pointed defined in the dentition is established relative to a point in the face or on the surrounding body.

53. The method according to claim 1, wherein at least one horizontal line and/or the vertical lines and/or the grid and/or a point and/or area thereof is individually oriented and/or aligned relative to at least one point, feature and/or particularity, which can be determined for example by the program, by its operator, a worker, user and/or controller, etc.

54. The method according to claim 1, wherein the areas and/or points on the lines and/or in the grid (e.g., intersecting point, defined grid element and/or defined point therein, point on a line, etc.) that align themselves, and hence the grid and/or lines by features or distinct and/or constructed points, can also be determined for example by the program, by its operator, a worker, user and/or controller, etc., for example.

55. The method according to claim 1, wherein all points, e.g., intersecting points, constructed and/or naturally existing distinct points, etc., can form intersecting lines among and with each other, which thereby generate data concerning about relations and/or patterns, e.g., of points, intersecting points, etc., relative to each other and to the environment, or to the space in which they are located, and/or about relations between the lengths and/or position of lines, angels they include and/or surfaces and/or planes and/or spaces that they form and/or localize and/or envelop, that can hence be used for identification and/or verification, and/or along with information usable for this purpose, e.g., about the body posture and/or position and/or head position, e.g., via the pupil and/or head location, etc., so that the latter can be ascertained.

56. The method according to claim 1, wherein all naturally marked or naturally existing, artificially generated and/or artificially distinct and/or constructed and/or intersecting points, the connecting lines and/or lines, angles, surfaces and/or planes and/or spaces available for selection form at least one pattern and/or pattern relations and/or proportions, which can be and are used for identification and/or verification, which can be used for identification and/or verification.

57. The method according to claim 1, wherein connecting lines (or planes) and/or lines (planes) and/or grid lines intersect at least a defined, e.g., prescribed plane and/or line and/or the section edge of the image or a portion thereof, thereby creating a pattern that can be used for identification and/or verification.

58. The method according to claim 1, wherein the number and/or type and/or which of the points, intersecting points, connecting lines and/or lines and/or grids/grid network elements, the width of grid elements, number of distinct and/or constructed points, points intersecting with each other and/or the section edge of the image can be prescribed by the individual structures of the person, living being and/or individual to be identified and/or verified, and/or by the evaluator of this method and/or the programmer and/or by the safety requirement of the user of this program, etc.

59. The method according to claim 1, wherein distinct and/or constructed points, lines, connecting lines and/or patterns are compared by an evaluator who overlays the data and/or information and/or patterns and/or images visually(,) via computer or the like.

60. The method according to claim 1, wherein the relation between one or more of the aforementioned features of teeth, tooth or tooth sections and the surrounding personal features is used for purposes of identifying persons, living beings and/or individuals.

61. The method according to claim 1, wherein only individual features (e.g., also points, lines, planes, surfaces, planes, and/or spaces), particularities and/or characteristics thereof, identification features and/or parts thereof peculiar to and/or characterizing the person, living being and/or individual to be identified and/or verified, but at least one, is acquired and/or stored as the basis for reference data and/or acquired in a new acquisition as part of identification and/or verification, as well as used for purposes of verification and identification.

62. The method according to claim 1, wherein individual features that are peculiar to the person, living being and/or individual to be identified or verified, but characterizes at least one of the latter, provide reference data and/or are used in a new acquisition as part of identification and/or verification within the search program for preselecting reference data.

63. The method according to claim 1, wherein, for example, the ID, chip card, etc., contains data about personal features (teeth and/or surrounding body structures and/or parts thereof) as data and/or images, etc., based on which the search program selects the reference data.

64. The method according to claim 1, wherein, for example, the ID, visa, chip card, etc., contains data about personal features (e.g., teeth and/or surrounding body structures and/or parts thereof) as images and/or structures (pattern, roughness), which are also acquired using acquisition equipment (e.g., laser, camera, sensor, etc.) in addition to the structures located on the person, living being and/or individual during identification and/or verification, wherein either the acquisition of data based, for example, on the ID and/or chip card, etc., form the reference data for the feature acquisition data based on the person and/or those form the reference data for acquiring data based on the ID and/or chip card.

65. The method according to claim 1, wherein the acquisition based on ID and/or chip card need not involve the same acquisition system as the acquisition of features relating to the person, living being and/or individual.

66. The method according to claim 1, wherein, for example, one or more acquired features, feature data, images, etc. are acquired in one and/or more of the aforementioned methods and/or in one or more previously known conventional methods, forming a data code, e.g., as a pin code, code word replacement, and/or the reference data for acquisition by means of another and/or different type of and/or one or several of the aforementioned methods.

67. The method according to claim 1, wherein the acquisition and/or a specific acquisition scope of data only takes place after the event requiring an identification and/or verification has been duly evaluated.

68. The method according to claim 1, which utilizes electromagnetic radiation with wavelengths outside that of light.

69. The method according to claim 1, which combines acquisition via electromagnetic radiation having wavelengths outside that of light with acquisition, for example, via image acquisition, camera systems, laser, etc., in conjunction with one or more of the preceding claims.

70. The method according to claim 1, which utilizes the data obtained during acquisition via electromagnetic radiation with wavelengths outside that of light in order to identify or verify a person, living being, item, material, etc. by comparison with data from acquisition, for example, via image acquisition, camera systems, lasers and/or utilizing light in the visible or invisible spectral range, etc., in conjunction with claim 1.

71. The method according to claim 1, wherein features are detected to generate a pattern in 2D and/or 3D, with and/or without the use of a coordinate system, with and without use of a grid, wherein the pattern provides data useful for identification and/or verification.

72. The method according to claim 1, wherein the information content of surfaces, spaces, grid elements, areas, etc. (e.g., hues, gray scaling, quantities and density of measuring points, number of pixels or bits, etc., e.g., images surfaces, pixels, etc.) provide clues as to the structures and distinct points and/or for detecting areas and/or features.

73. The method according to claim 1, wherein data compression takes place by compiling data, information and patterns, e.g., forming a superposed pattern or data computations, e.g., vectors or matrix descriptions.

74. The method according to claim 1, wherein the filed reference data from the acquisition of at least one identification feature encode and/or contain (personal) data about the person or, during application on an item, data and/or information about the latter.

75. The method according to claim 1, comprising the adjustment or selection (e.g., by factory, user, operator, person to be identified and/or verified, etc.), e.g., of the localization, size, number, and patterns of the acquisition areas and/or identification features (e.g., on dentition, body, etc.) and/or data to be used.

76. The method according to claim 1, which utilizes a neuronal network.

77. A system and/or device for eventual acquisition and/or data reconciling, comprising an acquisition device (e.g., at least one receiver and/or sensor and/or detector and/or camera and/or camera system with or without at least one light emitter and/or lighting unit, e.g., at least one (light) receiver, sensor, detector, etc.) and processing and/or comparison device (e.g., processing unit, central or decentralized data storage device for reference data and/or code data, personal data, etc.).

78. The system and/or device according to claim 77, which contains at least one laser light emitter and a suitable sensor and/or detector and/or camera, or it contains for example at least one sensor and/or detector and/or camera and/or image acquisition device, etc.

79. The system and/or device according to claim 77, wherein the latter is portable, and/or enables data exchange and/or data processing and/or data comparison with a data pool of reference data and/or characterizing and/or descriptive and/or personal data even over extended distances via a wireless connection, e.g., radio, and/or forms a toll system in combination with a transmitter and receiver system to additionally acquire current data (speed, traversed distance, elapsed run time, etc.).

80. The system and/or device according to claim 77, wherein the sensors lie in a U-shaped profile, tracing a U around the face and head and/or body of the subject to be identified and/or verified.

81. The system and/or device according to claim 77, wherein a magnification system, e.g., lenses, is located between the conventional systems used or usable for this purpose and the exemplary object, or processing on a digital level, for example, enables a magnification.

82. The system and/or device according to claim 77 for use in distance identification, characterized in that, e.g., lenses, are located between the conventional systems used or usable for this purpose and the exemplary object, or processing on a digital level, for example, enables a zoom.

83. The system and/or device according to claim 77, wherein the light emitter outputs light with a power on the object measuring at least the power of sunlight, and/or wherein the light emitter outputs light with powers on the object that at most lie below the power damaging to humans or the feature, depending on application, and/or wherein the light emitter preferably outputs infrared light.

84. The system and/or device according to claim 77, which utilizes a neuronal network for this purpose.

85. The system and/or device according to claim 77, which comprises instructions, e.g., writing and/or words, visual and/or acoustic, for imparting instructions to the person to be verified or the living being to be verified, etc., and/or a mirror for orienting the person and positioning the personal feature to be drawn upon for identification or verification, and/or comprises a target searcher and/or target indication for the viewing direction, e.g., in the form of a laser or image, etc.
